(19) United States
(12) Patent Application Publication
(10) Pub. No.: US 2025/0097034 A1
(43) Pub. Date: Mar. 20, 2025

(54) SECURE VIRTUALIZATION AUTHENTICATION

(71) Applicant: Adiseshu Hari, Holmdel, NJ (US)

(72) Inventor: Adiseshu Hari, Holmdel, NJ (US)

(21) Appl. No.: 18/888,573

(22) Filed: Sep. 18, 2024

Related U.S. Application Data
(63) Continuation-in-part of application No. 18/470,057, filed on Sep. 19, 2023.

(51) Int. Cl. H04L 9/32; H04L 9/30; H04L 9/40

(52) U.S. Cl. CPC H04L 9/32; H04L 9/3073; H04L 63/1466; H04L 63/166

(57) ABSTRACT

A method for validating a bio-locked identity of a user in secure virtualization authentication (SVA) System, including: sending by the user a first bio-locked identity validation request toward a first validator; receiving a first out-of-band communication from the first validator; responding by the user to the first out-of-band communication from the first validator using deep biometric authentication; and receiving an authentication state of the user from a SVA platform.

### FIELD OF THE DISCLOSURE

### Related Application Data

This application claims priority to U.S. patent application Ser. No. 18/470,057, filed on Sep. 19, 2023, the entire contents of which are hereby incorporated by reference.

### BACKGROUND

### Field of the Invention

Various exemplary embodiments disclosed herein relate to Secure Virtualization Authentication (SVA) including a secure, tamper-resistant, virtualization-proof, password-less, network-based technology providing authentication-as-a-service for both session-based and message-based internet applications.

### Background of the Invention

The rapid rise of the Internet as the dominant service delivery platform for all types of end-user applications and services has provided great convenience but has also raised great security issues. The security of Internet-based applications relies on two factors: first, establishing a secure connection between the application provider and the user, and second, authenticating the user. While the first factor is considered a solved problem with today's network transport protocols like SSL/TLS, the second factor, namely authenticating the user at the end of the secure connection is still a problem that has not been solved in an error-free, tamper-resistant way.

The Internet authentication problem is that of identifying the correct user across the Internet in such a manner that other users cannot impersonate that user.

### SUMMARY

A summary of various exemplary embodiments is presented below.

Various embodiments relate to a method for validating a bio-locked identity of a user in secure virtualization authentication (SVA) System, including: sending by the user a first bio-locked identity validation request toward a first validator; receiving a first out-of-band communication from the first validator; responding by the user to the first out-of-band communication from the first validator using deep biometric authentication; and receiving an authentication state of the user from a SVA platform.

Various embodiments are described, wherein the out-of-band communication uses one of a messaging application, a voice application, a video application and in-person communication.

Various embodiments are described, wherein deep biometrics includes human recognition based upon personality traits and personal knowledge of the user received from the out-of-band communication.

Various embodiments are described, wherein a bio-locked identity is a public key-based identity.

Various embodiments are described, further including: sending a second bio-locked identity validation request toward a second validator when a first validation score of the first validator does not exceed a validation score threshold; receiving a second out-of-band communication from the second validator; and responding by the user to the second out-of-band communication from the second validator using deep biometric authentication, wherein the authentication state of the user is authenticated when the combination of the first validation score and a second validation score of the second validator exceeds the validation score threshold.

Various embodiments are described, further including: determining that the first validator is in a validated state; and setting a first validator score of the first validator to a default value.

Various embodiments are described, further including: determining that the first validator is not in a validated state; and setting a first validator score of the first validator to half or less of its default value.

Various embodiments are described, including: determining validation state of the first validator; setting a validator score based upon the default value and the validation state; and setting a first validator timeout value.

Various embodiments are described, further including setting a first validator score of the first validator to a default.

Various embodiments are described, including adding the first validator to a current validator list when the first validator is not on a current validator list.

Various embodiments are described, further including: deleting the first validator from a validator list when the first validator time value is exceeded; and deleting the first validator score from a current validator score.

Various embodiments are described, further including associating a first key pair with the user at a SVA Client.

Various embodiments are described, further including associating a second key pair with the user at the SVA Platform.

Various embodiments are described, further including: signing by the SVA Client an authentication request the bio-locked identity to produce a signed authentication request, wherein the signed authentication request is signed by a private key of the SVA Client; and receiving from the SVA Platform a signed authentication response message, wherein the signed authentication response messages is signed by the SVA Platform using a private key of the SVA Platform and signed by an application using a private key of the application.

Further various embodiments relate to a method for validating a bio-locked identity of a user in secure virtualization authentication (SVA) System, including: receiving by a validator a first bio-locked identity validation request from the user; sending by the first validator a first out-of-band communication toward the user; receiving a response by the first out-of-band communication from the user; validating the user using deep biometric authentication; and sending an authentication state message for the user toward a SVA platform.

Various embodiments are described, wherein the out-of-band communication uses one of a messaging application, a voice application, a video application, and in-person communication.

Various embodiments are described, wherein deep biometrics includes human recognition based upon personality traits and personal knowledge of the user received from the out-of-band communication.

Various embodiments are described, wherein a bio-locked identity is a public key-based identity.

Various embodiments are described, including: receiving an out-of-band communication from the user indicating that a user device is lost; and locking the device that is lost.

Further various embodiments relate to a method for validating a bio-locked identity of a user in secure virtualization authentication (SVA) System, including: receiving by a SVA Platform a first signed authentication request for the bio-locked identity from a SVA Client, wherein the first signed authentication request is signed with a private key of the SVA client; signing by the SVA Platform the first signed authentication request to produce a second signed authentication request, wherein the second signed authentication request is signed by a private key of the SVA Platform; and sending by the SVA Platform the second signed authentication request for the bio-locked identity toward an application server hosting an application.

Various embodiments are described, further including: receiving a first signed authentication response message from the application server, wherein the first signed authentication response message is signed by a private key of the application; signing by the SVA Platform the first signed authentication response message to produce a second signed authentication response message, wherein the second signed authentication response message is signed by the private key of the SVA Platform; and sending by the SVA Platform the second signed authentication response message toward an SVA Client.

Various embodiments are described, further including: recording by the SVA Platform audit information regarding messages processed by the SVA Platform.

Various embodiments are described, further including Quantum-Safe operations with key rotation based on multiple keys. Each entity in a SVA System, such as the SVA Client, the SVA Platform and the Application Server can store not just a single public-private key pair for pair wise communication, but multiple public-private key pairs. This allows for key rotation, support for multiple key algorithms, and replacement of existing key generation algorithms with Quantum-Safe algorithms as necessary.

Various embodiments are described, further including Man-in-The-Middle (MITM) attack detection and mitigation using Bio-locked Channel (BLC). The Bio-locked channel (BLC) between the SVA Client and the Application Server facilitates secure out-of-band communications between a user and the Application Server to allow for verification of keys exchanged during application setup to detect a MITM attack, and to prevent such MITM attacks by exchanging session setup parameters over the BLC rather than the open Internet. A MITM attack works by intercepting the flow between the client and the server and spoofing the server. This can be detected by checking that the connection key received by the client does not match the connection key received by the server. However, this checking requires a secure, out-of-band path between the client and the server which is typically not present. However, the BLC does provide such a secure, out-of-band path which can be used by the application server to pass the connection key it has received to the SVA client. The user can then compare the connection key present at the app at the user end with the connection key retrieved over the BLC and see if they match or not.

Beyond MITM detection, it is possible to mitigate and eliminate MITM issues by simply passing the connection key over the BLC from the application server to the SVA client, which can then pass it to the app. Since no negotiation of the connection key takes place, it is not possible for any MITM attack to snoop and intercept the traffic since it originates in an encrypted state.

Various embodiments are described, further including continuous authentication of application session using BLC. Sensitive actions request by an app can be confirmed over the BLC, thus preventing session hijacking from affecting applications.

Various embodiments are described, further including Enrolled Identity service. A service is provided where a user can Bio-lock ownership of a digital identifier like an email address or a phone number of a web site, thereby preventing hackers from claiming ownership of that identifier.

Various embodiments are described, further including Bio-locked Tokens (BLTs) for bio-locked out-of-session transactions. The ability for one user to send a bio-lock a message to another user where the SVA System ensures that the enrolled identity sending the message is bio-locked to the sender and the enrolled identity receiving the message is bio-locked to the receiver. This provides guarantees to the sender that only the designated recipient can view the transaction and that the transaction originated from the designated sender.

Various embodiments are described, further including a Bio-locked MultiSig cryptocurrency wallet. Compared to conventional crypto wallets, where the crypto transactions are secured by a single key which can be stolen, the SVA System allows for a Bio-locked MultiSig wallet to be created as an added value-added service where each crypto transaction is protected by two separate and independent keys, one at the SVA Client and one at the SVA Platform. The SVA Platform key can only be unlocked if the user is validated using their bio-locked identity (BLI), thus providing a Bio-locked MultiSig Wallet service.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates virtualization of a user.

FIG. 2 illustrates the use of a secure channel to provide out-of-band security and authentication.

FIG. 3 illustrates a block diagram of a SVA System (SvaSys).

FIG. 4 illustrates a view of the SvaSys focusing on the Secure Virtualization Authentication (SVA) components.

FIG. 5 illustrates deep biometric authentication by air-gapped It's Me doorbell protocol.

FIG. 6 illustrates how Alice may be validated to the SVA platform by Bob.

FIG. 7 illustrates the signing of the authentication request.

FIG. 8A illustrates the set up for application authentication of Alice.

FIG. 8B illustrates a SVA Bio-locked Channel (BLC) message flow.

FIG. 9 illustrates an SVA application one-time password (OTP) login message flow.

FIG. 10A illustrates an SVA one-click application login message flow using the Secure Launcher.

FIG. 10B illustrates a single-sign on (SSO) process.

FIG. 10C illustrates a SSO process for use with non-browser, standalone application.

FIG. 11 illustrates a SVA two-factor authorization message flow.

FIG. 12A illustrates the message flow for the continuous authentication of in session requests.

FIG. 12B illustrates application of MITM detection using BLC according to embodiments of the present invention.

FIG. 12C illustrates application of MITM mitigation using BLC according to embodiments of the present invention.

FIG. 12D illustrates the structure of SVA identities according to embodiments of the present invention.

FIG. 13 illustrates the Bio-locked token (BLT) message flow.

FIG. 14 illustrates a flow diagram of how the plain text input is converted into a BLT that is encrypted and signed.

FIG. 14A illustrates a first use case of ticketing for BLTs.

FIG. 14B illustrates a second use case of BLTs as a user-to-user and user-to-bank virtual check.

FIG. 14C depicts a third use case illustrating the power of BLTs to simply and secure all types of financial transactions.

FIG. 14D depicts a fourth use case illustrating the power of BLTs to simply and secure all types of financial transactions.

FIG. 15 illustrates a list of user services that might appear in a menu.

FIG. 16 illustrates a menu of items associated with validator actions tab.

FIG. 17 illustrates a menu of items associated with validatee actions tab.

FIG. 18 illustrates a menu of items associated with the validator list tab.

FIG. 19 illustrates the application services tab.

FIG. 20 illustrates the add application tab and login to application tab in more detail.

FIG. 21 illustrates the add account sharing to application tab.

FIG. 22 illustrates the edit account sharing application tab.

FIG. 23 illustrates the join account sharing application tab.

FIG. 24A illustrates a user selecting an application and logging in.

FIG. 24B illustrates the flow for continuous authenticated access to a shared account.

FIG. 25 illustrates the pending notifications tab.

FIG. 26 illustrates the secure launch services tab.

FIG. 27 illustrates the secure launcher list tab.

FIG. 28 illustrates the BLT services tab.

FIG. 30 illustrates the external identity enrollment services tab.

FIG. 31 illustrates a validation logic flow chart.

FIG. 32 illustrates a flow diagram of the user and device life cycle.

FIG. 33 illustrates the architecture of the SVA platform.

FIG. 34 illustrates an exemplary hardware diagram for implementing the SVA System, client secure component, application, the application server, the SVA Platform.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of Secure Virtualization Authentication (SVA) systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

The rapid rise of the Internet as the dominant service delivery platform for all types of end-user applications and services has provided great convenience but has also raised great security issues. The security of Internet-based applications relies on two factors: first, establishing a secure connection between the application provider and the user, and second, authenticating the user. While the first factor is considered a solved problem with today's network transport protocols like SSL/TLS, the second factor, namely authenticating the user at the end of the secure connection is still a problem that has not been solved.

The Internet authentication problem is that of identifying the correct user across the Internet in such a manner that other users cannot impersonate that user.

The focus of this disclosure is on Internet applications and services that provide native application-based (app-based) or web browser-based access via end-user client devices like PCs, tablets, and phones to back-end, centralized services that are located elsewhere on the Internet. Throughout the disclosure the terms application, application and service will be used interchangeably. Also the terms user and human will be used interchangeably.

While all users are familiar with the ubiquitous password-based authentication scheme used by Internet services to authenticate users at the login prompt at the start of a service session, user authentication is actually needed not only in that context, but in the three following contexts. The first context is application login authentication. This is the initial login prompt discussed just above to initiate a session. The second context is application in-session request authentication. This is needed in the middle of the session to prevent scenarios in which the user has logged in but is away and some other user has taken over the session. The third context is out-of-session communication from application (and other users). This is needed for apps and services to deliver notifications and announcements, for example account statements or alerts about suspicious account activity. This is of particular interest to applications which do not have a client-side application installed in the client device and therefore rely on generic messaging services like email to deliver notifications. A comprehensive solution to user authentication needs to address not only the first context, but also the second and third contexts.

Passwords are the primary means of authenticating users. However password-based authentication solutions are not really secure, because it is possible for others to guess, steal or sniff the password from both the user side and the server side.

The step up from password-based authentication is digital certificate-based authentication, in which the user maintains a public key-private key pair for each application with the public key shared with the application. The user uses the private key to sign authentication requests which are verified by the application back-end using the user's public key. In this case, the back-end only knows the public key, and thus the authentication credentials, which is the private key cannot be compromised at the server side. The issue here is the cumbersome process of certificate creation and storage, which has kept certificate-based authentication away from the mainstream. Furthermore, the private keys can still be stolen by stealing the key storage device such as hardware tokens.

Credential stealing, whether that of passwords or physical keys is just one example of the fundamental security issue with authentication that we refer to as virtualization attacks. Typically, virtualization refers to the creation of a software replica or clone of some existing software or hardware. In the context of this disclosure, however, the term is broadened to include all aspects of interception or unauthorized usage. Virtualization is the enemy of authentication as authentication requires uniqueness, which is destroyed by virtualization. To be more specific, virtualization leads to two major authentication issues. The second issue is discussed below, but the first issue is the input virtualization attack where the input authentication credentials may be stolen or redirected via input virtualization. Identity relies on uniqueness, and virtualization destroys that uniqueness. The definition of virtualization may be extended to not only software replicas, but also any form of interception (e.g., key logging) or unauthorized usage (e.g., stolen physical keys). The key takeaway from virtualization attacks is that there is a need to move away from bearer credentials that can be stolen, like passwords or hardware tokens, to non-stealable, virtualization-proof credentials. For example, hardware tokens offer tamper-resistance, but can be stolen and thus fail the non-stealable criteria.

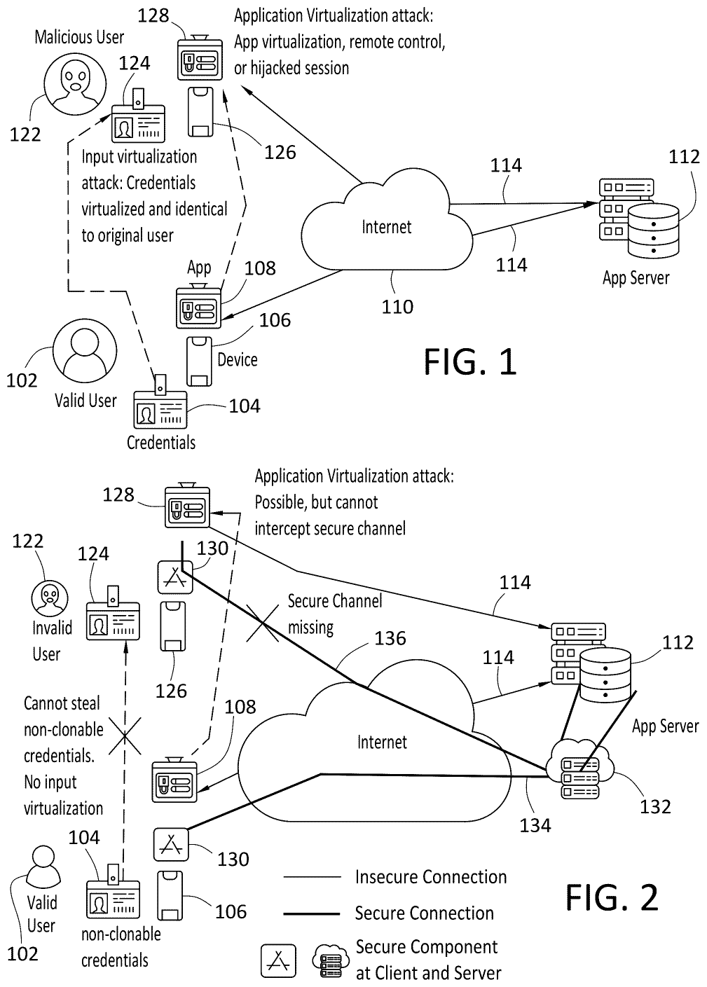

FIG. 1 illustrates virtualization of a user. A valid user 102 has an application 108 running on a user device 106. The valid user 102 has user credentials 104 associated with the application 108 that are used to log into the application 108. The application 108 may serve as an interface to an application or service running on an application server 112. The application 108 communicates with the application server 112 using a communication channel 114 through the internet 110. When a malicious user 122 steals the user credentials 104 and stores them as virtualized credentials 124, the malicious user 122 may log into a malicious application 128 running on a malicious device 126 and access the account of the user on the application server 112.

One non-stealable candidate solution is biometric authentication. In this case, user biometrics at login-time are compared with stored biometrics and if they match, the private keys are released to the user. While this sounds good in theory, in actual practice, current biometrics have not proven to be non-spoofable. This is because current biometrics are based on physical features, like fingerprints or eye scans. While this works very well for physical verification of identities, which was the original use case in passwords and other government issued IDs, physical feature based biometrics are not a good candidate for network-based verification. Physical biometrics are few and once compromised cannot be replaced. Furthermore, they are not universal, because not all people have the requisite physical feature being fingerprinted. The non-universal applicability of current physical biometrics means that current biometrics based authentication is a convenience alternative to password-based authentication, not a replacement. This leads to an insidious problem, as people assume that biometric authentication is secure, while it is neither secure nor does it replace the even more insecure password based authentication.

The rise of AI, deep fakes and 3D printing makes the long term future of feature-based, or shallow biometrics uncertain. What is needed is a move towards “deep” biometrics where the inner personality traits and inner personal knowledge of a person are analyzed to identify people, rather than surface physical characteristics which can be easily mimicked. Deep Biometrics are defined as human recognition based on intrinsic human traits, behavior, and knowledge as recognized by close friends and family. This may include, for example, personality traits and personal knowledge as evidenced by a detailed interactive conversation between the subject and close friends and family.

A hypothesis underpinning this disclosure is that humans are the best judges in human identification, and in particular, it is not possible for one human to impersonate another human under sustained, interactive interrogation by close friends and family of that human, as that mimic would have neither the detailed nuances of personality nor the detailed knowledge of the shared experiences that the human shared with his friends and family. The deep biometrics-based authentication solution is therefore based on an authentication mechanism in which a user is authenticated not by himself, but by a set of chosen human authenticators, called validators through an out-of-band process of interactive interrogation. This implementation of deep biometrics human-to-human authentication may be called “It's Me” authentication, because a user will typically only have to use that phrase to identify himself to other users. Therefore, because no authentication credentials are actually emitted by the user into any login session, this approach eliminates any virtualization attack.

It was stated above that virtualization leads to two major authentication issues and the first issue is that of Input virtualization attacks. The second issue is an application virtualization attack. Once the credentials are input to the application and a valid, logged-in session is created, the application and its network connection can be virtualized or cloned or controlled remotely, leading to session hijacking. Even with digitally signed authentication, the issue of session hijacking remains unsolved, as the session can still be hijacked after successful authentication.

FIG. 2 illustrates the use of a secure channel to provide out-of-band security and authentication. The solution is to not inject any credentials in-band, but to inject credentials out-of-band through a secure communication channel 134 that is a secure, non-virtualizable, out-of-band communications channel. In this case, a client secure component 130 provides a One Time Password (OTP) for the application login screen and link the OTP to the actual credentials via this out-of-band secure communication channel 134. At the application server 112 there is a server secure component 132 connected to the secure communication channel 134 that communicates with the client secure component 130. As a result, copying credentials from the application screen will not work due to the single use nature of OTPs. Because the malicious user 122 is missing the secure communication channel 136, they are not able to log into the server secure component 132. This provides an authentication solution in the first context that solves the application virtualization issue.

OTPs still do not protect against session hijacking of an active session, but the out-of-band secure communication channel 134 serves as a continuous authentication mechanism for all application actions. This means that each action requested in the application screen, for example transfer of money or a purchase, may be authenticated through the out-of-band channel. So if the application session is hijacked, there will be no authentication available for the application action and therefore the action will fail. Thus the out-of-band continuous authentication provides a solution for the second context that also solves the application virtualization issue.

An embodiment of an authentication solution using deep biometrics will be described. Deep biometrics or biometrics based on intrinsic human traits, behavior and knowledge as recognized by close friends and relatives may be used as the basis of an embodiment of an authentication solution, and the authentication credentials will be carried through an out of band secure channel between the user and the application.

The authentication solution, called Secure Virtualization (SVA), is based on three integrated features to solve the authentication problem in the three contexts described earlier:
i) Deep Biometrics-based, public key-based identities, or Bio-Locked Identities for application login authentication;
ii) Deep Biometrics-based, public-key-based secure channel, or Bio-locked Channels for application in-session request authentication; and
iii) Deep Biometrics-based, public-key-based, secure token-based encryption services, or Bio-locked Tokens (BLT) for out-of-session communication from application (and other users). SVA provides a solution to internet authentication of human users.

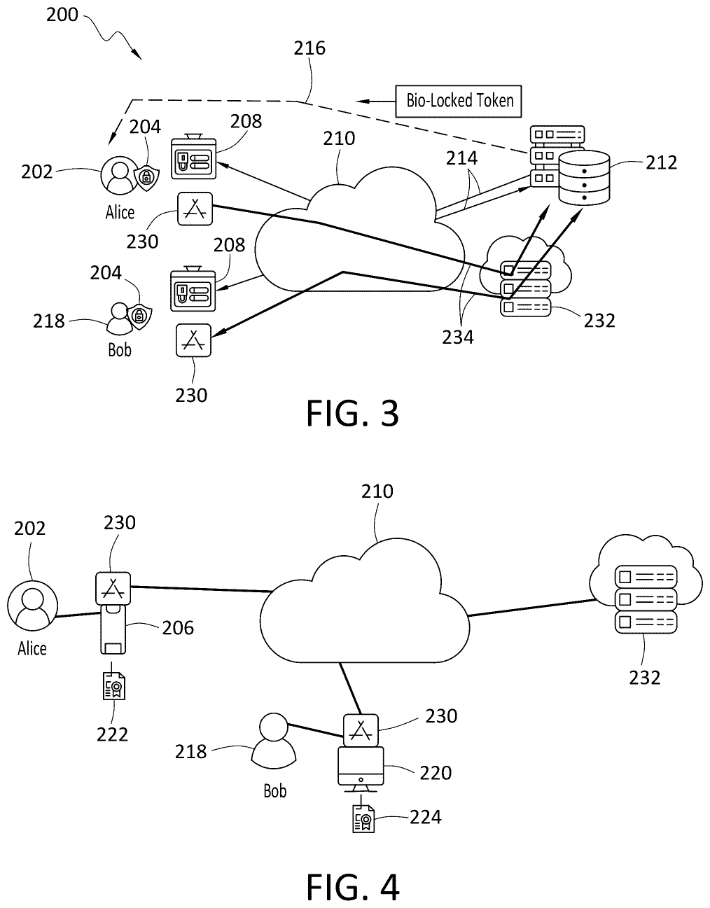

FIG. 3 illustrates a block diagram of a SVA System (SvaSys). The SvaSys 200 includes a client side software component called the SVA Client 230 that is installed on one or more user devices and a server side component called the SVA Platform 232 residing in the cloud. The SvaSys may include a plurality of users with one or more SVA Clients 230. Each SVA Client 230 maintains a secure connection 234 to the SVA Platform 232 and only communicates with the SVA Platform 232. Thus all communications are mediated by the SVA Platform 232.

As part of enrollment in the SvaSys 200, each user provides one or more validators who are other SVA users, who are willing to validate and authenticate the user (validatec) on demand using out-of-band communications methods, such as audio or video calls, or direct in person or face-to-face meetings. The success or failure of the validation procedure are communicated to the SVA Platform 232 by the validator. The authentication state of the user is maintained not at the SVA Client 230 of the user, but by the SVA Platform 232 based on inputs received by the validators of the users. As a result, the SVA Client 230 at the user being validated does not store any authentication credentials which can be stolen or redirected. The SVA Platform 232 unlocks or locks the SVA Client 230 based on whether the user is authenticated or not respectively. When the SVA Client 230 is locked, the only action the user is permitted to perform is to validate himself. Once the user is validated and the SVA Client 230 is unlocked, the SVA Client 230 can then be used to authenticate applications.

As long as a user is validated, the user is authenticated and the user's identity is unlocked at the SVA Client 230 based on instructions received from the SVA Platform 232. For each application/service, the user identity is encoded by a pair of public-private key pairs, one maintained at the user end in the SVA Client 230 and one maintained at the SVA Platform 232. As long as the user is in an authenticated state, whenever an application requires authentication the SVA Client 230 sends authentication responses signed by the SVA Client 230 private key to the SVA Platform 232. This in turn verifies that the user is authenticated before forwarding the authentication response to the application after additionally signing the authentication response with the SVA Platform 232 private key. Even if the SVA Client 230 is virtualized or the user device is stolen, as long as the user is not authenticated, it will not be possible for any malicious user to impersonate the user, as that would fail the “It's Me” deep biometrics-based validation test. Note that loss of the SVA Client 230 private key is not an issue, as user authentication requires both the SVA Client 230 and the SVA Platform 232 to sign authentication responses.

Enrollment may also include digital user assets such email addresses, phone numbers, websites, random numbers and hashes with each asset associated with a key at the SVA Client and a key at the SVA Platform. A service may be provided where a user can Bio-lock ownership of a digital identifier like an email address or a phone number of a web site, thereby preventing hackers from claiming ownership of that identifier.

FIG. 4 illustrates a view of the SvaSys focusing on the SVA components. A user Alice 202 has a user Alice device 206 running the SVA Client 230. The user Alice device 206 may securely store Alice's certificate 222. A second user Bob 218 may act as a validator of user Alice 202. User Bob 218 may have user Bob device 220 that is running SVA Client 230 and that stores Bob's certificate 224. The SVA Clients 230 of Alice and Bob communicate with SVA Platform 232 via the internet 210.

As described in earlier sections, bio-locked identities are the network-based deep biometric identities whose authentication state is maintained at the SVA Platform 232 based on human validation of the user and are mapped to two key pairs, one maintained at the SVA Client 230 and one maintained at the SVA Platform 232.

Bio-locked identities provide the following benefits as compared to any other Internet identity credentials like passwords, or SMS messages, or regular private keys on client device or external hardware tokens. First, they are non-stealable, i.e., no other person can go to a new device and use that identity. Second, they are universal as they can be used by all people unlike physical biometrics. For example, fingerprints do not work for people without fingers. Third, they can withstand SVA Client private key loss, for example, the loss or theft or failure of a device with the SVA Client 230 installed. Fourth, being network-based, the identity can be reinstated even with the loss or theft or failure of device with SVA Client 230 installed. This device's loss of resilience is what allows bio-identities to truly replace passwords, not just complement them as in current biometrics solutions. Finally, bio-identities provide a digital authentication audit trail, as all authentication transactions are processed through a central platform, which may maintain a transaction history even with end user or application back-end failures. The central platform for processing all authentication requests also has other benefits. For example, all authentication requests and responses may be accurately timestamped to a single source, and it is possible to instantly remove bio-locked identities without the possibility of stale credentials being used.

A Bio-locked Channel (BLC) is defined as an out-of-band logical communications channel between an application back-end and a user that uses the Bio-locked identity (BLI) of the user to sign messages and thus provide an authenticated communications channel between the application and the user. Bio-locked Channels are created on a per-application basis by integrating SVA-based authentication into Internet-based applications and services. With SVA-integration, each application back-end maintains a secure connection to the SVA Platform 232, which forms a part of the Bio-locked Channel.

Each Bio-locked Channel includes two parts: a secure connection from the SVA Client 230 application to the SVA Platform 232; and the secure connection from the SVA Platform 232 to the application back-end. This design removes the need for the SVA Clients 230 and the application back ends to do any routing, because both send all authentication requests and responses to the SVA Platform 232.

As mentioned above regarding bio-identities, per-application client side keys are generated at both the SVA Client 230 and the SVA Platform 232 for each application, providing user privacy by creating separate user identities for each application. Corresponding to Bio-locked Identities (BLI) for users, an Application Identity consisting of an application server public key and a SVA Platform public key is used to sign BLC messages going from the application back-end to the user. Within the Application Identity, the Application server key may or may not be generated on a per-user basis, while the SVA Platform public key can be the same one used in the BLI. BLC Authentication responses can only be sent by a validated user and are signed by both the SVA Client 230 and the SVA Platform 232 before being routed to the application back-end. Note that while BLC messages need to be signed by both the initiator and the SVA Platform 232 to be valid at the recipient, the signatures are done sequentially, with the source signature in the BLC message toward the SVA Platform 232 and the SVA Platform signature appended as the message is routed to the target. Besides the actual authentication request and response payloads, each message in the BLC channel includes an Account ID and a Session ID. The Account ID is assigned at the account creation time and allows for account persistence when adding the SVA Client 230 on new devices or replacing lost or stolen user devices. The Session ID helps distinguish between multiple instances of the same application.

Bio-locked Channels provide an out-of-band mechanism for applications to authenticate users without the need to inject any authentication state in the application. Instead, two separate methods are provided for associating an app session with a user.

In the first method, a one-time-password (OTP) is created for each login at the SVA Client 230, which is filled in the application login screen by the user. A regular OTP which is a single string, while typical application login screens have two input fields-a username field and a password field. For convenience, the SVA Client 230 may be configured to split the OTP string into two parts so that both the user field and the password field can be filled without any modification in the application login screen. The OTP is only available for SVA Clients 230 which have been validated, thus locking the channel to the bio-locked identity of the user. The same OTP is communicated via the SVA Platform 232 to the application back-end, allowing the application and the SVA Platform 232 to correlate the OTP to the user. Based on the degree to which the application login screen can be modified, the OTP used to link the application login screen to the bio-locked identity can be presented in alternate ways, for example, as a QR code in either the application login screen or the SVA Client 230, that can be scanned by the other party.

The OTP is also associated with a Session ID that is sent in each message in the Bio-locked Channel, allowing for per-session Bio-locked Channels to be multiplexed over the single connection between the SVA Client 230 and the SVA Platform 232. Similarly, the Session ID is used to multiplex traffic from multiple sessions over the SVA Platform 232 to an application back-end connection.

In the second method, a Single-Sign On (SSO) implementation is used to map the app to the user. The advantage of our technique is that it extends the benefits of SSO authentication, which has been restricted to web browsers so far, to be extended to standalone apps which are the dominant form of app implementation on smartphones.

In traditional SSO, the login web page of an application provides links to one or more SSO providers. Clicking on such a link transfers the web page to the SSO provider. Web browsers maintain sessions and session continuity using cookies, which are opaque tokens stored at the web browser and returned to the web server for each web request. Assuming the user has previously logged into the SSO provider, the SSO provider uses the cookies in the incoming request to identify the user. Once the user is identified, the SSO provider redirects the browser to the original web server of the application along with some additional parameters identifying the user. The same information is sent over a private back channel between the SSO provider and the application. The application uses the parameters in the web request and the back channel message toward associate the web request with a user and to log the user in.

The advantage of the SSO-based login is that it is a well understood mechanism and is very popular in the web browser domain since it eliminates the need for users to maintain per-website passwords and to type them in for each website. However, as smartphones have transitioned from using web browsers to standalone app clients, this has caused problems with SSO usage since SSO is a web browser-based technology that uses cookies to let SSO providers know the user. If a standalone app were to send a web request to the SSO provider, the SSO provider would have no idea about the user and would have to present a login prompt for the SSO provider each time, thus nullifying the single click benefit of SSO and exposing the user's SSO credentials to the application

However, the system disclosed herein allows for SSO for standalone apps without exposing any user credentials to the standalone app We assume that the standalone app is associated with a web-based back end. This is true of virtually all non-trivial apps. In our SSO-based login embodiment, we embed a web browser within the SVA Client. While most cellular networks prevent devices from being accessed as servers, in this case, the web browser is bound to the local loop-back address 127.0.0.1, also known as the localhost address and is always available to local applications. In the SSO implementation described herein, the web link in the app's SSO link will point to a loop-back address based URL, such as https://localhost: 8888/sso?referer=app.com/login. This will transfer control to the SVA Client's embedded web server, which pops an authentication dialog window for the user. Once the SVA Client verifies that the user is authenticated and that the user confirms the login request, the SVA Client redirects the app back to the app's web server with a parameter (the session ID) identifying the user, and also communicates the session ID and the user's application-specific Bio-locked Identify (BLI) over the Bio-locked Channel (BLC) to the app back end via the SVA Platform. This allows the app back end at the app web server to map the incoming web request from its app with the appropriate user and log the user in.

As described above, the SSO solution works for apps local to the device. Using the Secure Launcher described previously, the SSO solution can be extended to other devices as well, by embedding the web server in the Secure Launcher as well, thus providing a SSO solution for standalone apps both local and remote.

The Bio-locked channel (BLC) between the SVA Client and the Application Server facilitates secure out-of-band communications between a user and the Application Server to allow for verification of keys exchanged during application setup to detect a MITM attack, and to prevent such MITM attacks by exchanging session setup parameters over the BLC rather than the open Internet. A MITM attack works by intercepting the flow between the client and the server and spoofing the server. This can be detected by checking that the connection key received by the client does not match the connection key received by the server. However, this checking requires a secure, out-of-band path between the client and the server which is typically not present. However, the BLC does provide such a secure, out-of-band path which can be used by the application server to pass the connection key it has received to the SVA client. The user can then compare the connection key present at the app at the user end with the connection key retrieved over the BLC and see if they match or not.

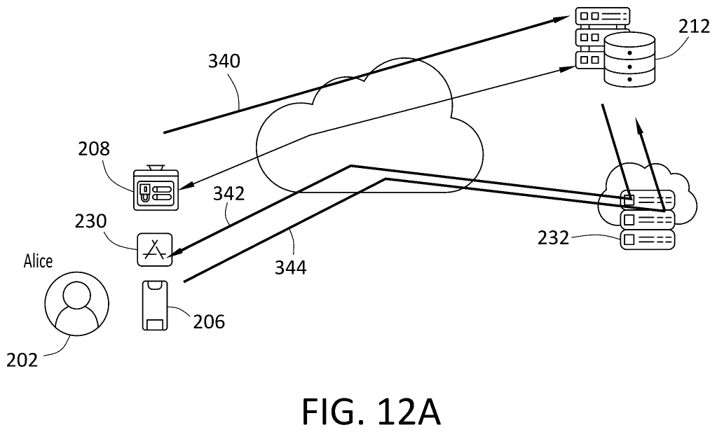

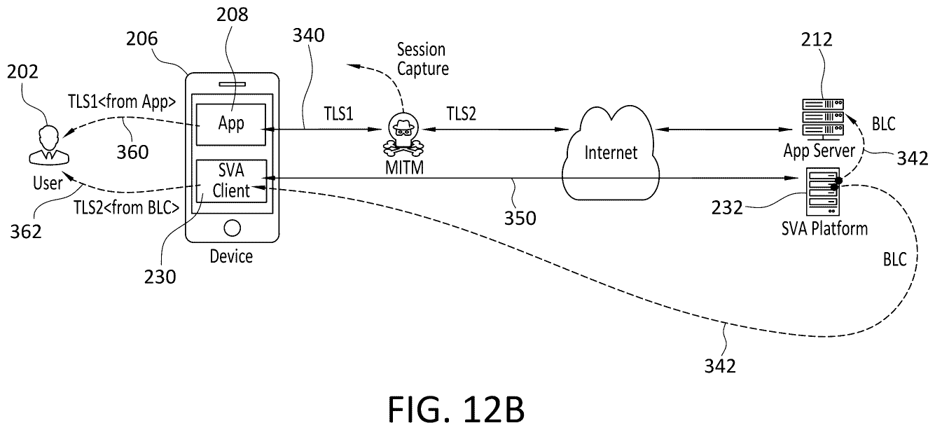

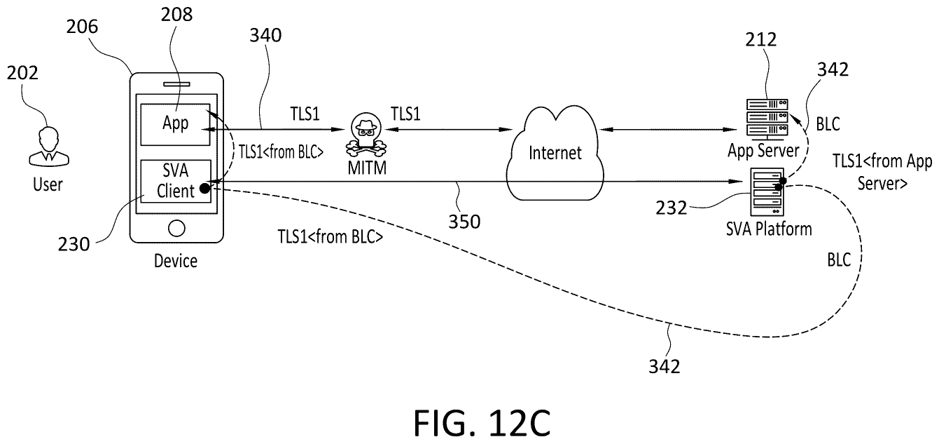

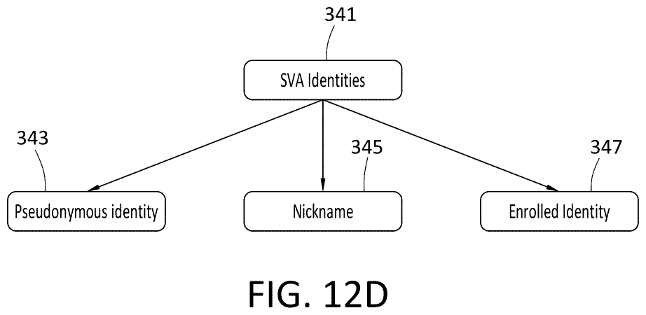

Beyond MITM detection, it is possible to mitigate and eliminate MITM issues by simply passing the connection key over the BLC from the application server to the SVA client, which can then pass it to the app. Since no negotiation of the connection key takes place, it is not possible for any MITM attack to snoop and intercept the traffic since it originates in an encrypted state. MITM detection is described below with reference to FIG. 12C, and MITM mitigation is described below with reference to FIG. 12D.

Using the Bio-locked Channel for logging in provides protection against input virtualization, but not against application virtualization, as it is still possible to virtualize and hijack the application at the client end once the authentication is done. However, the key feature of the Bio-locked Channel is that it is always available to validated users even after the initial login authentication, a feature we refer to as continuous authentication. The Bio-locked Channel can therefore be used to validate any in-application request, thus providing protection against application virtualization and session hijacking. For example, if the application receives a request to send money, or make a purchase, the application may always use the Bio-locked Channel to verify and authenticate this request before acting on it.

The key differentiator between Bio-locked Channels and other out-of-band communications channels like email or SMS (Short Messaging Service or phone text messages) is that it is bio-locked, i.e. it cannot be subject to a bearer-based attack or an application virtualization attack. SMS, for example, requires a cellphone with an active SIM card, which is a problem while traveling abroad or in low cellular coverage areas. Furthermore, cellphones can always be “SIM-jacked” and have the phone number transferred without the user's knowledge to another user. The bidirectional and interactive communications channel permits apps to not worry about security while designing client apps, as all requests can be authenticated through the Bio-locked Channel, e.g. email or bank application “Send” or ecommerce “Buy” button. In addition, the locking of the channel is symmetric to both the user and the application, meaning that it is not possible for anyone to hijack or impersonate the app, due to the signing of all app messages by the Application Identity. A further feature of Bio-locked Channels is that the actual application can run on another device, not just this device, as there is no communication between the application and the Bio-locked Channel. Beyond the OTP for initial login on the client side application, the Bio-locked Channel can also be used to pass various communication parameters to the client application, such as domain name server (DNS) mappings, application channel encryption keys, and session cookies. Manually inputting such details, including the OTP is cumbersome, and a mechanism will be discussed, called Secure Launcher, which automates the launching of the client applications with parameters received from the Bio-locked Channel. In the reverse direction, the Bio-locked Channel can pass various user parameters to the application, such as GPS location, device configuration, local network conditions, and current validation time.

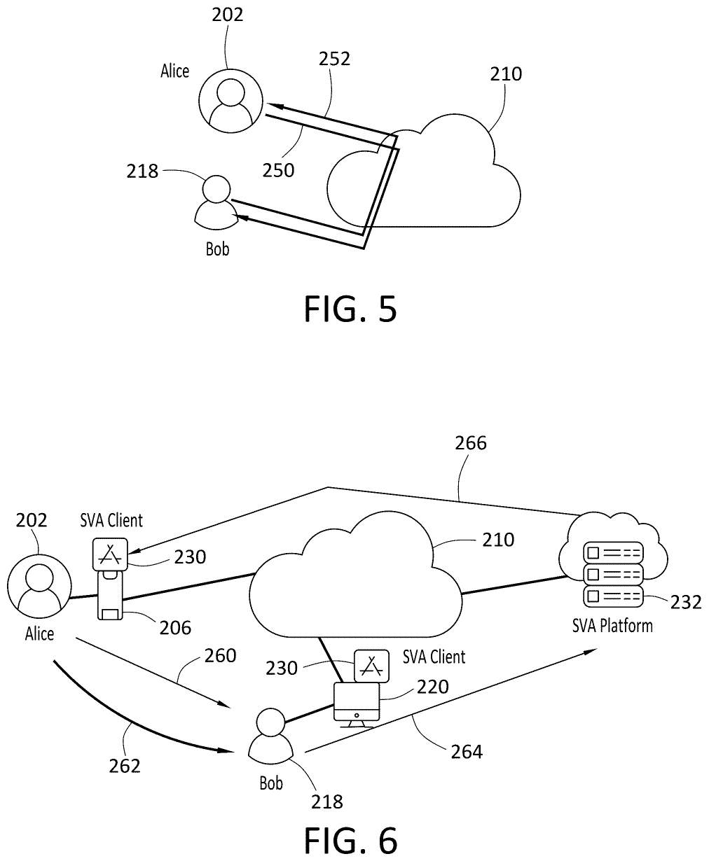

FIG. 5 illustrates deep biometric authentication by air-gapped “It's Me” doorbell protocol. User Alice 202 seeks to be authenticated and send an ID request 250 to user Bob 218. Bob may be a relative, friend, or trusted acquaintance who recognizes and knows Bob and can verify Bob's identity. Bob can send back a ID response 252 stating that they know it is Alice 202 contacting them.

FIG. 6 illustrates how Alice 202 may be validated to the SVA Platform 232 by Bob 218. Alice 202 first sends a validation request 260 to Bob 218. This request may be displayed on user Bob device 220 by the authentication SVA Client 230. Then Alice 202 communicates to Bob 218 out of band, and Bob 218 authenticates that it is indeed Alice 202 who is seeking authentication. Bob 218 then sends a message 264 to the SVA Platform 232 that indicates the Bob 218 has validated Alice 202. The SVA Platform 232 the communicates 266 the authentication state of Alice 202 back to Alice. This results in a SVA bio-locked identify for Alice based upon Bob's validation of Alice's identity.

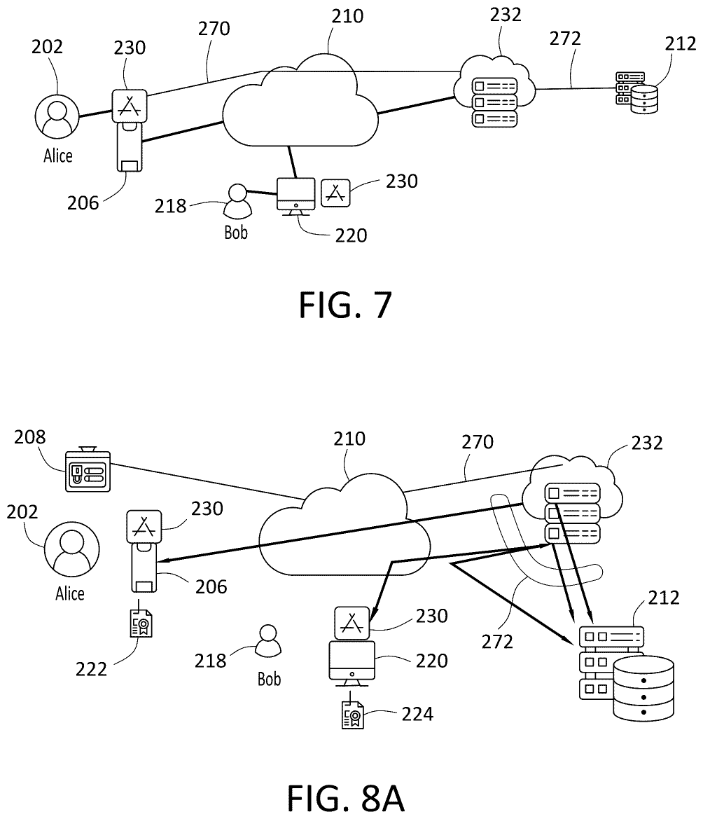

FIG. 7 illustrates the signing of the authentication request. The authentication request for a SVA bio-locked identity includes two signatures and not one to be valid. The authentication SVA Client 230 sends an authorization request 270 to the application hosted by application server 212 via the SVA Platform 232. This authorization request is signed by the private key of the authentication SVA Client 230. The SVA Platform 232 receives the signed authorization request and signs it with its private key. Then, the authorization request that the application server 212 receives is signed by both the authentication SVA Client 230 and the SVA Platform 232. This improves the security of the authorization protocol as a malicious user cannot affect the system if they take over just the SVA platform 232 or the SVA client 230.

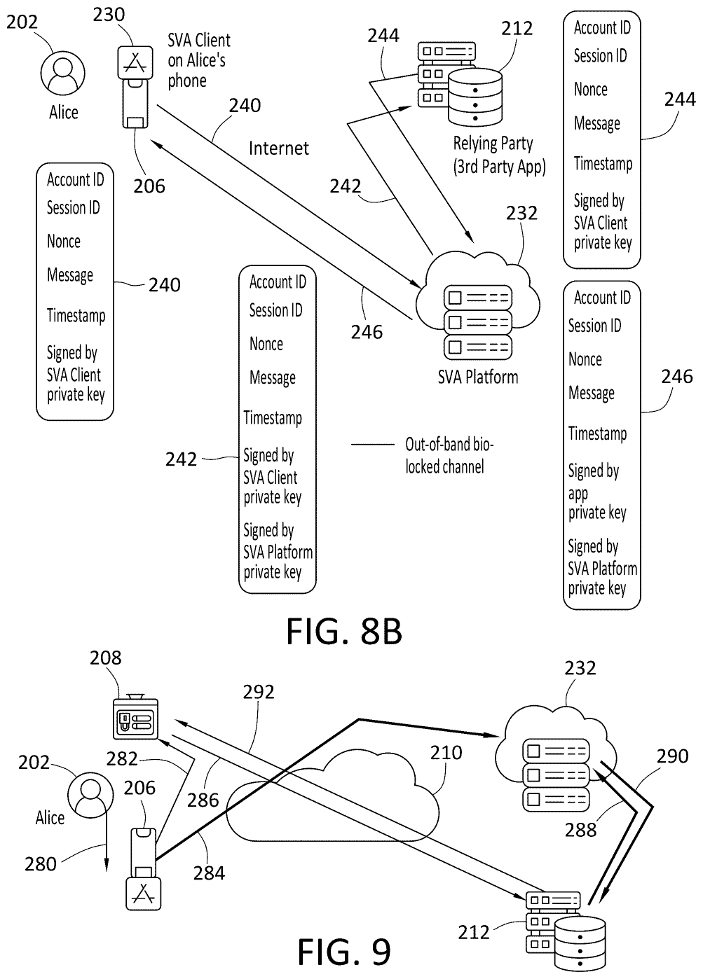

FIG. 8A illustrates the set up for application authentication of Alice. The authentication SVA Client 230 is preconfigured to accept an OTP in the username and password fields. The authentication SVA Client 230 is preconfigured with a list of 3rd party applications. The user Alice device 206 includes Alice's certificate 222 that includes application specific certificates. The user device 220 includes bob's certificate 224 that includes application specific certificates. There is an application data path between the application 208 and the SVA Platform 232. Further, there are a number of different out-of-band bio-locked channels. Specifically, the application server 212 sets up a secure connection to the SVA Platform 232. The purpose of the OTP is to link together an application running on a for example a user device and a the SVA Client 230 running on that same device. It helps the SVA Platform 232 to know that a particular application belongs to a specific user.

FIG. 8B illustrates a SVA BLC message flow. The SVA client 230 sends a message 240 towards the SVA platform 232. The message 240 may include an Account ID, Session ID, Nonce, Timestamp, Message, and is signed by the SVA Client private key. The inclusion of a Nonce in the message prevents the use of replay attacks. The Timestamp allows for auding of the system. The SVA platform 232 then signs the message 240 received from the SVA client 230. This message 242 signed with the SVA platform private key is then sent towards the application server 212. The application server 212 verifies that the message 242 is signed by both the SVA client 230 and the SVA platform 232. The application server 212 associated the Session ID with a specific user and application. The application server 212 the returns a message 244 back towards the SVA platform 232 that is signed by the application private key. The message 244 includes the Account ID, Session ID, Nonce, Timestamp, Message, and signature. The SVA platform 232 receives the message 244 and signs it using the SVA platform private key. The SVA platform 232 then sends a message 246 to the SVA client 230 that is signed by both the application private key and the SVA platform private key. The SVA client 230 then verifies the signatures from the application server 212 and the SVA platform 232. This completes the message exchange between the SVA client 230 and the application server 212. The use of two signatures from two independent entities in the message exchange makes it virtually impossible to spoof the communications.

FIG. 9 illustrates an SVA application OTP login message flow. First, Alice 202 generates an application OTP using the authentication SVA Client 230 by selecting the application from the list of registered applications 280. Next, Alice enters the OTP in the application login screen 282. Then the authentication SVA Client 230 sends 284 the OTP in the application authorization request signed by the per-device per-application private key to the SVA Platform 232 over an out-of-band bio-locked channel. The application 208 next returns 286 the OTP to the application server 212 via a foreground application data path. The application server 212 sends the OTP to the SVA Platform 232 for user lookup 288. Then the SVA Platform 232 matches the received OTP to the user and sends the signed authorization request from the authentication SVA Client 230 to the application server 212 via a foreground application data path after additionally signing the authentication message with the SVA platform secret key 290. The OTP and the unique platform generated user identifier (ID) are also included. Finally, the application 208 logs Alice in successfully after verifying the signed authorization request with the stored SVA Client public key and the SVA platform public key for that user ID 292.

As seen in FIG. 9, Bio-locked Channels supply an OTP that needs to be manually entered into the login screen of the app. There might also be additional configuration parameters that need to be supplied as well. Relying on the user to type in long, random alphanumeric sequences is not ideal. The problem of automated application launch with the desired parameters can be solved using a Secure Launcher, which is a software program capable of launching other programs. The Secure Launcher communicated with the SVA Client over a secure network connection. When the user needs to launch an application, instead of typing in an OTP password in the application screen, the user now simply taps the corresponding application icon in the SVA Client, and the SVA Client communicates with the Secure Launcher to start the desired application with the desired launch configuration parameters including the login details. The Secure Launcher can be a program that either runs on the same device as the SVA Client, or another device, providing single touch application login both in-device and out-of-device. The Secure Launcher also removes the need for multiple SVA Clients as a single SVA Client can be used to launch both local and remote programs. The Secure Launcher also allows easy use of devices without secure storage since no credentials or keys are stored in the Secure Launcher.

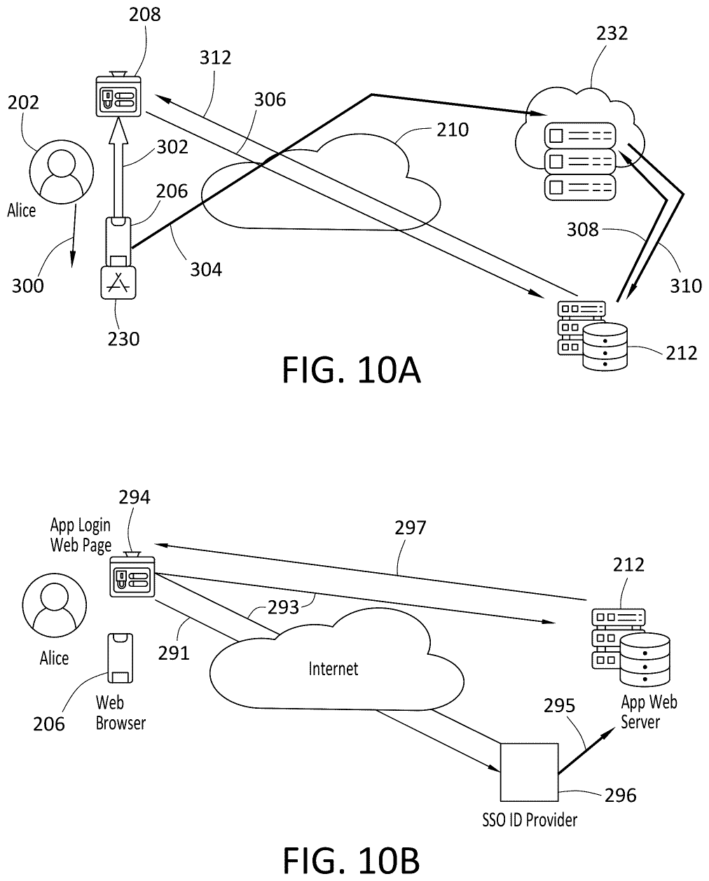

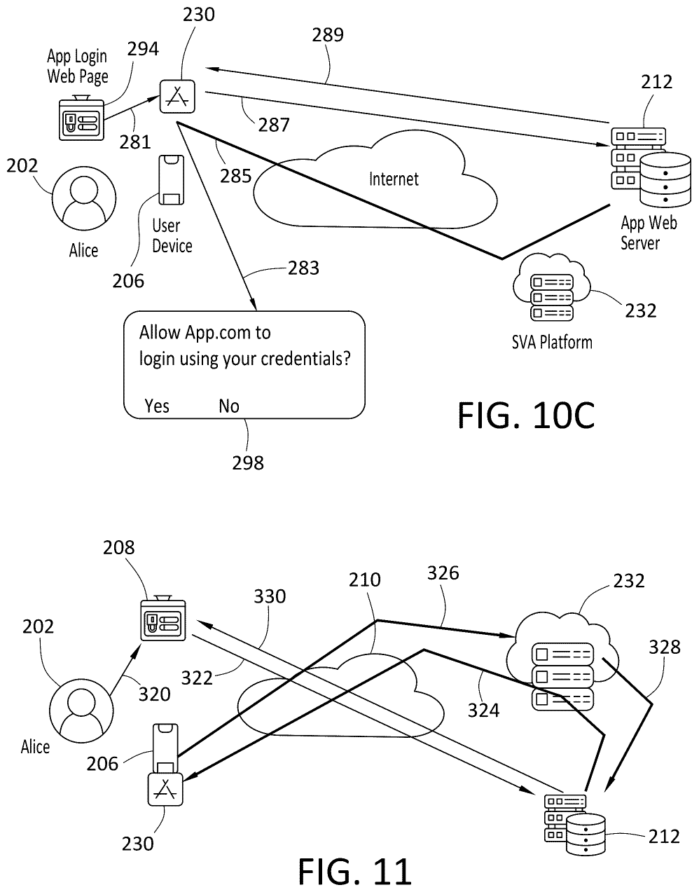

The SVA Client configures each app with a different key pair for each Secure Launcher that is automatically linked to the original key pair on this device. From the application perspective application instances on different devices don't share the same key pair. This allows for device specific personalization. FIG. 10A illustrates an SVA one-click application login message flow using the Secure Launcher. First, Alice 202 selects an application from the list of registered applications 300. Next, the secure launcher launches the application with the OTP as a parameter 302. In this approach the user does not need to manually enter the OTP into the application. Further the message 302 may include additional information along with the OTP, such as an IP address and encryption keys of the application server 212 and other information related to the application server 212 which may be visible on the internet. Knowing the IP address of the application server 212 means that a Domain Name Server (DNS) will not need to be used which DNS could be spoofed. Then the authentication SVA Client 230 sends 304 the OTP in the application authorization request signed by the per-device per-application private key to the SVA Platform 232 over an out-of-band bio-locked channel. The application 208 next sends 306 the OTP to the application server 212 via a foreground application data path. The application server 212 sends the OTP to the SVA Platform 232 for user lookup 308. Then the SVA Platform 232 matches the received OTP to the user and sends the signed authorization request from the authentication SVA Client 230 to the application server via a foreground application data path after additionally signing the authentication message with the SVA platform secret key 310. The OTP and the unique platform generated user identifier (ID) are also included. Finally, the application 208 logs in Alice successfully after verifying the signed authorization request with the stored SVA Client public key and the SVA platform public key for that user ID 312.

FIG. 10B illustrates a single-sign on (SSO) process. Various internet service providers provide a SSO where the login for the service provider is used to log into a third party website or service. For example, when a user navigates to a website 294 and a login screen is presented, one of the options may be to use a SSO instead of an login ID and password specific to the website. When the user selects the SSO option then a web request 291 is sent to the SSO ID provider 296. The web request 2391 may include login details that were stored in a web cookie. If a web cookie for the SSO is not present, then the user may login and a web cookie is generated for the SSO login. The SSO ID provider verifies the user using the cooking and redirects the web request back to the application 293. The SSO ID provider 296 also communicates with the application server 212 via a preconfigured back channel to associate the web session with the user. At this point, the application server 212 is able to now associate the web session with the user and login in the user successfully 297.

FIG. 10C illustrates a SSO process for use with non-browser, standalone application. Today many user devices use standalone applications to access web based applications and services over the internet. As a result, the cookie based SSO login procedure does not currently work with stand along applications. This is remedied by running a web server on the SVA client 230. The SSO login process for a standalone application will now be described. The user Alice 202 using a standalone application clicks on a login link on a website 294. This generates a web request 281 that is sent towards the SVA client 230. The SVA client 230 is running a web server dedicated to the application to provide the environment for interacting with the standalone application. Further, there is only one user associated with the application and the device, so the web server knows that this is the use associated with the application and device when they are logged into the SvaSys. The SVA client 230 provides a pop-up screen 298 that asks the user Alice 202 if they want to log in using credentials associated with the SSO. The user Alice 202 can then verify that they would like to do so. When the login is authorized by the user and the user is logged in, the SVA client 230 send a login authorization response 285 to the SVA platform 232 and the application server 212 using the BLC. The SVA platform 232 and the application server 212 then associate the web session with the user BLI and/or BLT. The application is the redirected 287 to the application server 212. The application is now verified to the application server 212 and the application server 212 may interact 289 with the application server 212. While SVA Authentication is designed to be fully password-less, it is necessary to provide an integration mechanism for existing legacy password based authentication schemes. In this case, SVA Authentication may act as a second authentication factor (2FA) to the existing password-based scheme. FIG. 11 illustrates a SVA two-factor authorization message flow. Here the BLC is used only as a second factor to authorize the user, without modifying the existing username/password-based authentication system. First user Alice 202 logs into the application 208 using an existing username and password 320. Then the application 208 sends the username and password to the application server 212 using a foreground application data channel. Next, the application server 212 verifies the username and password and sends an authentication request to Alice over the bio-locked channel for confirmation 324. Alice then confirms the authentication request and sends a signed response to the SVA Platform 232 via the bio-locked channel 326. The SVA Platform 232 sends the signed authentication request to the application server 212 after additionally signing the authentication request with the SVA platform private key 310. Finally, the application 208 logs in Alice successfully after verifying the signed authorization request with the stored SVA Client public key and the SVA platform public key for that user ID 330. The use of the SVA System as a second factor of authentication (2FA) prevents malicious users from using a stolen password in existing password-based authentication systems, since the malicious user will not have access to the BLC of the valid user, which is available after a deep biometrics-based authentication only to the valid user.

One benefit of the bio-locked channel is that it allows for continuous authentication of in-session requests that need to be secure.

FIG. 12A illustrates the message flow for the continuous authentication of in session requests. First, user Alice 202 makes an in-application request 340. For example, requesting to make a purchase. Next, the application server 212 sends an authorization request over the SVA secure bio-locked channel 342 to the authentication SVA Client 230. Finally, the user Alice 202 uses the authentication SVA Client 230 to send the authorization request back to the application server 212 via the SVA Platform 232.

The use of SVA uses a authentication SVA Client 230, a SVA Platform 232, and bio-locked channel to provide a secure out of band channel to authenticate users. This means that vulnerabilities found in the application input and the application itself cannot be exploited to take over the user's account using virtualization.

One issue with eliminating passwords is that there is no easy way of sharing an online account. Creating individual accounts is fine for free services, but incurs additional costs for paid accounts, such as Amazon Prime or Netflix. One solution is to link accounts at the application end, so that only one of the accounts needs to pay for service for all accounts. However, this requires additional work at the application back-end.

A simpler solution to account sharing is presented that is transparent to the application provider, may be enabled by the application on a per-account basis, and allows for very flexible account sharing scenarios. The solution leverages the networked nature of the SVA system to enable a user to log into an application with agreement from other users sharing the account.

In this embodiment of account sharing, first a primary user creates an account with an application. Second, the user configures additional identities (users) to access the account. The other identities need not have any preexisting accounts with this application provider and if they do, those accounts are independent of this shared account. Third, the account holder assigns numeric scores to each identity in a sample range, for example, the range 1-100. Successful authentication to the shared account requires that one or more identities agree to that authentication such that the scores of the identities sum up to more than an assigned value, say 100. This allows for very flexible account sharing options. For example, if each user is given a score of 100, then any user can login to the account (like password sharing). On the other hand, if there are N users and each user is given a score of 100/N, then all N users need to authenticate for the account sharing login to succeed.

Note that in all cases, there is only a single application instance that is launched at the device of the first initiator. Coordinated shared login is achieved by one user sending authentication requests to the other users, and only if the others agree, then the user obtains the OTP for login. Also note that irrespective of the score of each user, there is a single primary user who converts an existing account into a shared account by assigning additional users and scores to these users. It is the primary user who can edit the list of users and their scores and it is the primary user who can delete other users and revert the account back to a single user account.

Whenever transparent account sharing is configured for an application, the SVA Client 230 shows the application and the list of configured users. The first initiator simply contacts the other shared account users via the SVA Client 230 to get their permission for login by sending them authentication requests.

Applications often need to communicate with users even in the absence of an established session, for example, for user notifications, account statements, unusual account activities etc. This can be done by pushing notifications to the client-side app. However, not all applications have client-side apps and even for those that have client-side apps, the client-side application might not be installed. Thus, messaging channels such as email, WhatsApp (WA), SMS (texts) are often used for this purpose of pushing out-of-session application notifications. However, all these channels are subject to bearer-based attacks, e.g., email accounts can be hacked and even without hacking, sender spoofing is very common in email-based phishing attacks. What is needed is a mechanism to verify the integrity and authenticity of these messages, i.e., impose secure, authenticated messaging on insecure and unauthenticated messaging channels. This is provided by deep biometrically bound tokens that are defined as Bio-Locked Tokens (BLTs).

BLTs are digitally signed and encrypted tokens consisting of a source, a destination, a subject, and a payload, similar to emails. The signature and encryption is done using key pairs from the source and destination as well as the SVA Platform 232. Unlike regular emails, the source and destination are enrolled identities that are linked to bio-locked identities as described below and the entire token is first signed using the source bio-locked identity private key and then a SVA platform private key. The signed token is then doubly encrypted, first by the corresponding SVA platform public key and then by the destination bio-locked identity public key. The signature using the SVA platform private key verifies that this is an authentic Bio-locked Token while the encryption using the SVA platform public key ensures that the SVA Client 230 can only decrypt the Bio-locked Token when properly authenticated as the SVA Platform 232 will perform the first decryption using the SVA platform private key only when the SVA Client 230 is properly authenticated.

As a result, the BLT can only be decrypted by the appropriate destination bio-locked identity and no one else, and once decrypted, the destination can also verify that it could only have been sent by the indicated sender. The subject field, as in emails, allows BLTs to be threaded and grouped together. In addition to the above fields, there are additional security fields, for example a timestamp field and a nonce field, which help prevent replay attacks and help sequence BLTs.

The messages on the Bio-locked Channel are similar to the message encoded in BLTs (BLTs). One key difference is that Bio-locked Channel messages are tied to a Session ID, while there is no associated session in a BLT. The Session ID is instead replaced by explicit source and destination fields in a BLT. Another difference is that the Bio-locked Channel is designed for small, real-time, interactive message flow between the user and the application back-end. While the BLTs can also be used interactively with real-time messaging applications, the key advantage of BLTs is that they can be of arbitrary size, leveraging the ability of messaging apps to deliver large messages. For example, a multi-gigabyte file can be pushed as the payload in a BLT, while that is not the goal of Bio-locked Channel messages. The sign-then-encrypt policy of token generation allows the decrypted BLTs to act as signed tokens and be used as proof of receipt by the recipient, as the signatures of the sender and the SVA Platform 232 that sign the token can be verified by all.

While the SVA Platform uses a globally unique ID (GUID) to identify each user and application internally, there are no global identities visible outside the Platform. All identities are scoped to the parties that interact with that identity.

FIG. 12B illustrates the application of MITM detection using BLC. First, user 202 obtains 360 application (App) side TLS parameters (TLS1) from the client application 208. Next, user 202 obtains 362 App Server side TLS parameters (TLS2) from App Server 212 via the BLC 342. An MITM attack can be determined by comparing the two TLS parameters TLS1 and TLS2. When the man in the middle occurs, the TLS/SSL parameters change from one side of the MITM. For example, as shown, the MITM captures a session and changes the parameters to hide its existence. Therefore, when TLS2 are via the BLC, if there is a MITM, TLS2 will not match TLS1.

It should be understood that in FIG. 12B, the BLC 342 is shown as having two legs, one between the SVA client 230 and the SVA platform 232, and a second leg between the SVA platform 232 and the App Server 212. The two legs for a single BLC.

FIG. 12C illustrates mitigation of a MITM attack using BLC. As shown, the App Server 212 generates session TLS parameters TLS1 and sends them over BLC 342 to SVA Platform 232. SVA Platform 232 sends the TLS parameters TLS1 to SVA Client 230. The SVA Client is configured to send the TLS parameters TLS1 to the application 208. Application 208 initiates a TLS session to the App Server 212 using TLS parameters TLS1, without any parameter legitimation over the Internet. The MITM cannot spoof server keys and cannot intercept the TLS connection. That is, by removing the parameter negotiation, and launching the application with the parameters obtained directly from the server side via a BLC, the MITM only sees the encrypted traffic and cannot decipher it.

FIG. 12D illustrates the structure of SVA identities. The SVA identities 341 may include a pseudonymous identity 343, a nickname 345, and an enrolled identity 347.

The identity that a user creates when first joining the platform and specifying a set of validators is a pseudonymous identity 343, i.e., consistently unique, but not necessarily the only user identity. For example, a user can create one identity using one set of validators and another identity using another set of validators. While the SVA System does not prevent a single user from creating multiple identities, it discourages it by restricting each device to a single identity. Thus a user will need a separate device for each identity.

Enrolled identifies may be digital assets associated with a user, such as an email addreses, phone numbers, random numbers, etc. Each enrolled identity is associated with two keys: one at the SVA client the other at the SVA platform. The SVA platform key is available only for validated users (i.e., logged in), thus restricting the usage of the enrolled identities to validated users only.

Each pseudonymous identity is linked to the set of validators that validate that identity. Users identify their validators using nicknames 345, e.g. “Mom, Dad”, and similarly validatees identify users using nicknames, e.g., “Son”, “Daughter”.

As mentioned earlier, for each application a key pair is generated at the SVA Client and the SVA Platform and it is this combination that identifies the user to the application.

Since a user can only identify his validators, validatees and applications, a mechanism is needed for users to use Bio-locked Tokens to communicate with other users. This is done via enrolled identities 347, which allows a user to add additional identities once proof of ownership of identity is done. Examples of additional identities that can be enrolled include email addresses, bank accounts, phone numbers, DNS names, and websites. Beyond regular identities, enrolled identities 347 can be any type of non-fungible asset that can be uniquely identified, such as vehicles, properties and art works. All enrolled identities 347 need proof of ownership, for example email address proof of ownership requires that the user verify the contents of some messages sent to that email address. Like any other identity, each enrolled identity 347 generates its own SVA Client key pair and SVA Platform key pair, thus maintaining the isolation across identities.

Once enrolled, a Bio-locked Token can be created for a user using any enrolled user identity 347 and signed using any enrolled identity 347, allowing for example, to pay from a back account-based enrolled identity at one user to an email account-based enrolled identity at another user.

Enrolling an identity provides a registration service that allows a user to protect the identity and claim ownership by preventing anyone else from enrolling it. For example, assume the user Alice owns the email address alice@gmail.com and adds it to the SVA System as an enrolled identity by submitting to a proof-of-ownership test. Now, even if a malicious user were to hack into that email account and hijack it, they would not be able to enroll that email address with the SVA System and would thus be unable to send or receive BLTs with that email address. This provides a simple test to check if someone actually owns an email address or any other external identity. A BLT is sent to that identity, and the user is asked to decrypt that BLT. Inability to decrypt the BLT would indicate that the user does not own that identity. This type of test is very useful in verifying legitimate ownership before buying enrolled identity associated assets such as email addresses, domain names, or even physical non-fungible assets like property and artwork.

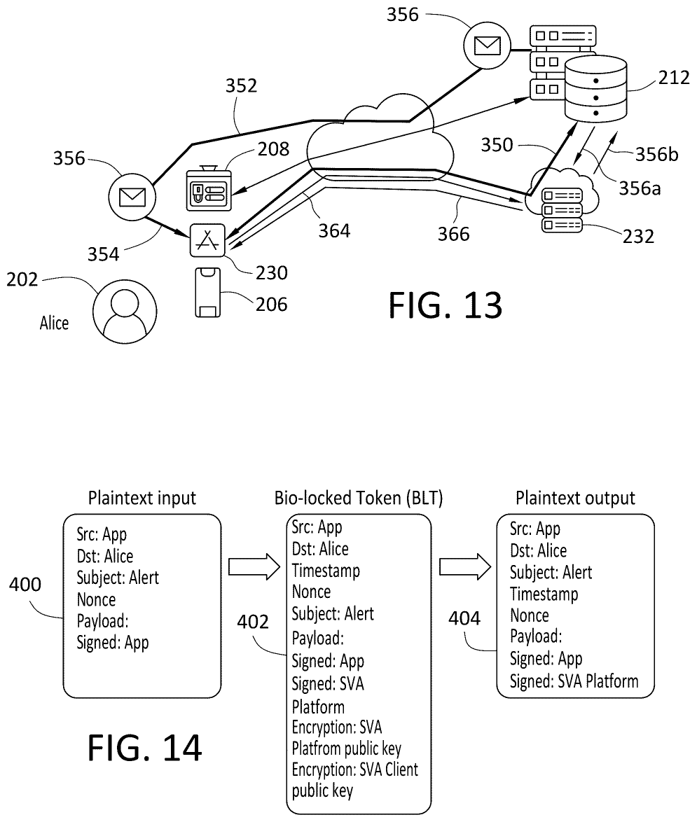

FIG. 13 illustrates the BLT message flow. Assuming the sender is an application back-end, the BLT message flow is as follows. First some provisioning steps are carried out. The application server 212 provides 356a the signed token template to the SVA Platform 232 specifying the source (itself), the destination (the selected user), the subject field (an arbitrary string that can be the same as a previous subject field), and the payload. The template is signed using the application's private key before handing it to the SVA Platform 232. The SVA Platform 232 signs the template using its private key and performs the first encryption of the all the token fields using its private key. The SVA Platform 232 then retrieves the public key of the selected user and uses it to encrypt the template a second time to create the BLT. The user could have multiple SVA Clients 230 installed in multiple devices, leading to multiple user keys. In such a case, the token actually contains multiple encrypted templates, one for each SVA Client 230, as each SVA Client 230 has its own set of public-private keys for each enrolled identity. SVA Platform 232 returns 356b the signed and encrypted BLT to App Server 212.

When an encrypted Bio-locked Token is received at the destination and decryption is requested, the SVA Client 230 will submit 364 the Bio-locked Token to the SVA Platform 232 to perform the first stage of decryption. The SVA Platform 232 will do this decryption only if the SVA Client 230 is associated with an authenticated user with the enrolled destination identity. Assuming the SVA Client 230 is authenticated, it then retrieves 366 the Bio-locked Token after the SVA Platform 232 decryption and performs the second level of decryption using its own public key to retrieve the unencrypted Bio-locked Token.

The combination of the signatures of the application and the SVA Platform 232 ensure that it is an authenticated token, while the double encryption using SVA Platform 232 and the user public key ensures that the user can decrypt the token only when authenticated, since the SVA Platform will not do the first decryption till the user is authenticated.

Once the token is generated at the sending end, the sender can either choose the SVA System to deliver it, or the sender can send it using any available communications or messaging channel to the user. The SVA System places limits on the size and frequency of BLTs that are transmitted by it, so if these limits are exceeded, for a large multimedia file payload, then a messaging or web-based download method might be preferable. If the SVA System is used to transmit the BLT, it is delivered directly to the SVA Client where it is available for decryption. The SVA System is able to route the BLT to the appropriate recipient the same way it routes other SVA System messages, such as for validation requests and responses. If a messaging app is used for BLT delivery, the recipient retrieves the Bio-locked Token from the messaging app and uses the SVA Client to decrypt the token and verify its authenticity.

The application server 212 generates the BLT and sends the BLT to the application 208 to transmit using any available communications or messaging channel to the user 352.

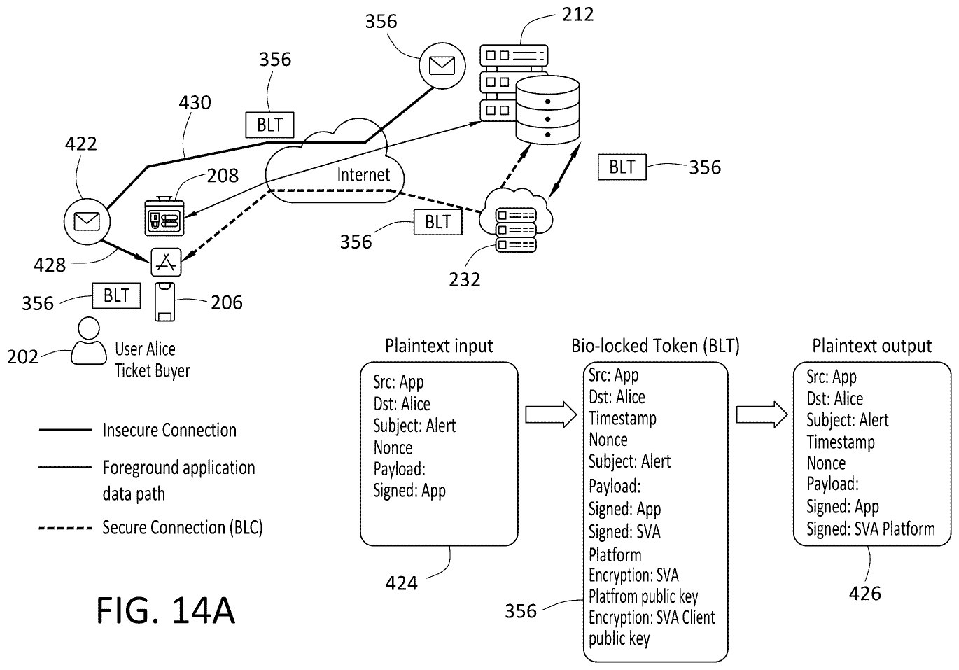

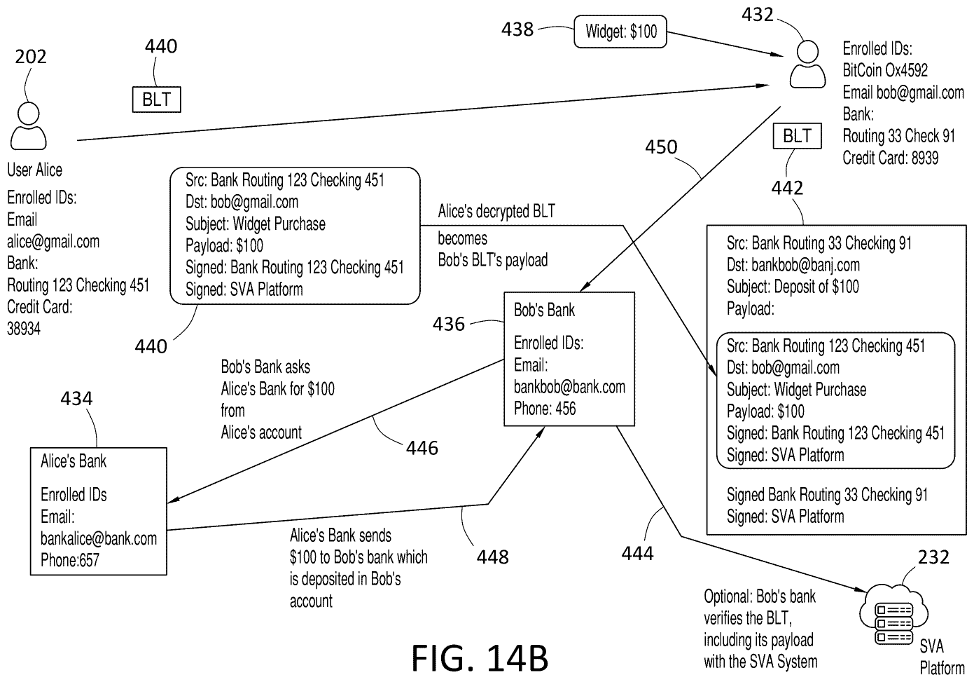

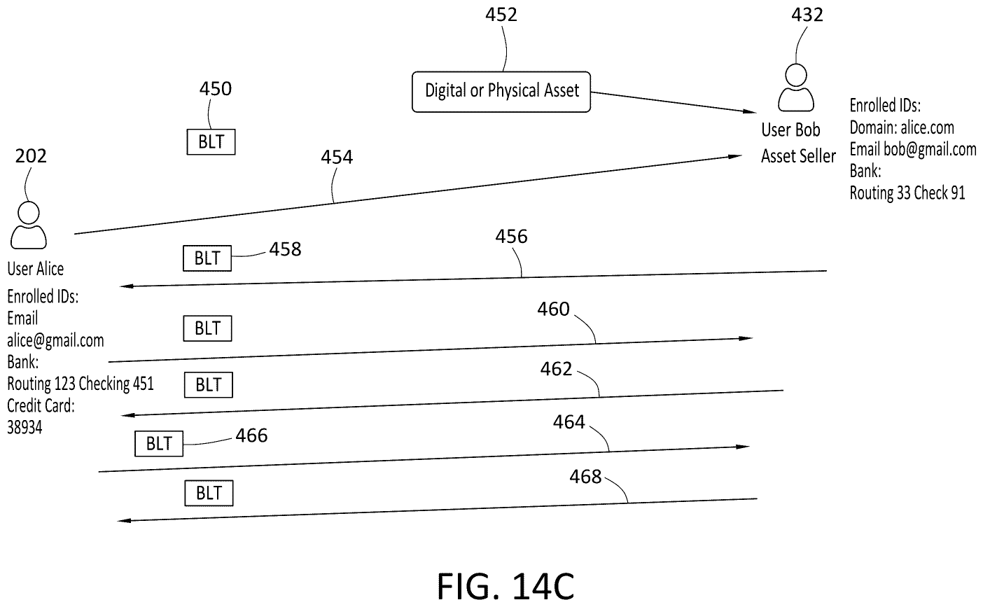

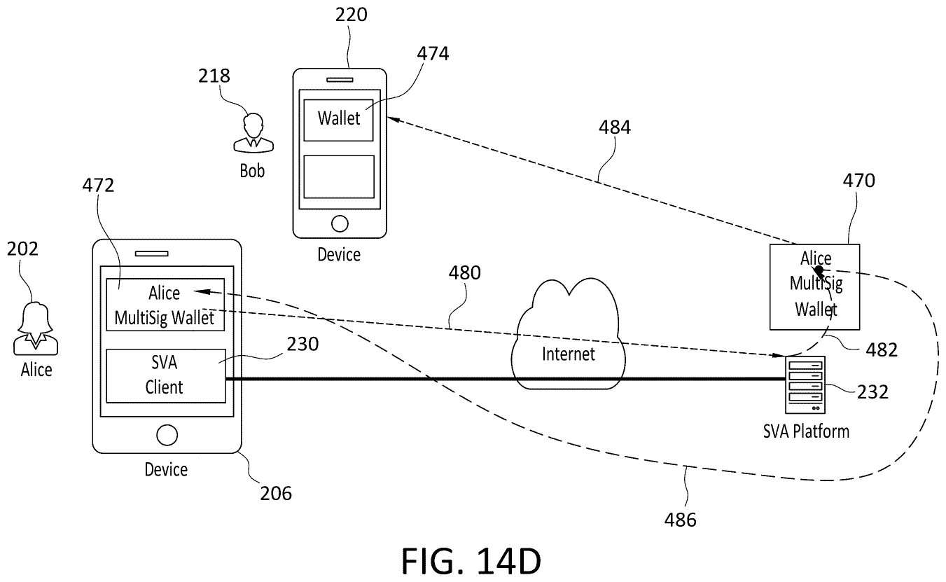

Alice 202 imports the BLT from the messaging channel and uses the SVA Client 230 to decrypt the token and verify its authenticity 354. FIG. 14 illustrates a flow diagram of how the plain text input 400 is converted into a BLT 402 that is encrypted and signed. The BLT 402 may then be decrypted by the recipient to produce in plain text 404 the payload of the BLT 402.

A decrypted BLT is a signed token and may be forwarded to other entities in decrypted form over a secure channel, or it may be sent as the payload of a new BLT to other entities over an insecure channel.

An important aspect of BLTs is that they may be used not only for application-to-user messaging, but also user-to-application, user-to-user, and application-to-application messaging. For user-to-user use cases, it is the user who initiates the BLT by specifying one of the enrolled identities as the source and a second user as the recipient in the BLT template that is input to the SVA Client 230. The process of creating the BLT is split between the SVA Client 230 and the SVA Platform 232. The SVA Client 230 signs the token template using the private key of the enrolled identity. It then relies on the SVA Platform 232 to also sign and encrypt the BLT using the platform key, retrieve the recipient public key, and use it to encrypt the BLT. At this point, the token is ready and encrypted and can be handed back to the user by the SVA Client 230.

As examples of user-to-user use cases, BLT may be used for user-to-user digital receipting, ticketing, and payment. In general, any form of communication which requires authentication and audit trailing can be used with BLTs, which makes it an ideal way of implementing various user-to-user financial schemes.

Not only may two-party transactions use BLT but also multi-party transactions using a series of interlinked two-party transactions. For example, a user may issue I owe you (IOU) notes using a BLT to another user, who can then cash them using a third user.

Or consider, for example, a buyer paying for a purchase using a credit card. The buyer sends the seller a BLT with a virtual credit card number, which is a masked version of the actual credit card number. The buyer also sends the credit company a BLT with the same virtual credit card number, which allows the credit card company to associate the virtual credit card with the actual card. Now when the seller sends the virtual card in a BLT to the credit card company, the credit card company can correlate the virtual card in the seller BLT to the virtual card in the buyer BLT to authorize this purchase and to charge the buyer.

User-to-application messaging can, for example, be used to send service requests to an application email address or send authenticated comments to a message board. Applications are identified using their DNS names or URLs.

Application-to-application use cases include various types of data feeds, e.g., streaming data feeds, and request-response-based network APIs which can now be authenticated without the need to exchange any credentials.

The use cases for BLTs will now be described. FIG. 14A illustrates a first use case of ticketing for BLTs. A natural first use case of BLTs 356 is in online ticketing, where it is necessary to ensure that the ticket not only reaches the right recipient, but also that the ticket cannot be tampered with or stolen. The usual way that online tickets are delivered is either by downloading the digital tickets directly to the user device from the ticketing website, or by receiving them via email. In the first case, the digital ticket is stored in the device and the device can be hacked and the downloaded ticket stolen. In the second case, the email account can be hacked and the ticket stolen. In both cases, the issue is that the digital asset, which is a ticket in this use case, is in plaintext and this allows a malicious actor to make use of the asset once its stolen.

BLTs 356 solve the problem by encrypting the digital asset before it is sent over a delivery channel. A simple way of using BLT for online tickets is as follows. The ticket seller asks for an enrolled Identity from each ticket buyer. This would typically be an email address but could also be a cellular phone number. Once payment is confirmed, the ticket seller (application server 212) would wrap the ticket in a BLT 356 with itself as the Source and the enrolled ID as the Destination, the ticket details in the Subject field and the actual ticket as the payload (see 424). This BLT template is signed by the SVA Platform 232 and encrypted with the public key of the Bio-locked Identity (BLI) corresponding to the supplied enrolled ID. If the enrolled ID is an email address, then the BLT is mailed 430 to that address, while if the enrolled ID is a phone, the BLT is sent via text messaging to that cellular phone. The recipient does not have to worry about his email or phone getting hacked, as the hacker will not be able to decrypt the BLT to retrieve the ticket. On the actual day of the performance and at the actual venue, the ticket buyer inputs 428 the BLT to the SVA Client 230 on his device and decrypts the BLT, yielding the ticket (see 426) which can then be presented after having been decrypted at the very last minute.

In the above use case, the enrolled ID was also used as the delivery mechanism, but in general, this need not be the case, for example, the buyer can give an email address for delivery, while providing a DNS name for the enrolled ID.

FIG. 14B illustrates a second use case of BLTs as a user-to-user and user-to-bank virtual check. Since BLT's 356 are digitally signed, they provide a simple way of sending money from one user to another, as well as from users to apps, web sites, financial institutions and banks and can thus serve as virtual digital checks. This use case illustrates the use of nested BLTs, in which the payload of a BLT can be another decrypted BLT. This utilizes the fact that while a BLT can only be decrypted by its destination, a decrypted BLT is a signed token and thus serves as an authoritative proof-of-receipt which can then be the payload of a BLT to another destination. FIG. 14B illustrates four entities, user Alice 202, user Bob 432, Alice's bank 434, and Bob's bank 436. All entities have enrolled identities in the SVA System and thus are capable of sending BLTs 356 to each other. The enrolled identities of Alice include her email addresses, her bank account which is identified by her bank's routing number and Alice's checking account number, and her credit card number. Correspondingly, user Bob has similar enrolled identities, but his bank 436 is different, indicated by a different routing number in the enrolled ID for his bank account. Each bank enrolls its email address, allowing the banks to receive BLTs which set their destination field to that email address.

Bob 432 has an item 438 for sale, and Alice 202 wishes to purchase the item 438. How the purchase process is completed using BLTs that function as virtual checks is now described.

First, Alice issues 440 a BLT with the source specified as its enrolled bank account and the destination set to Bob's email address. The payload contains the specified purchase price, which in this example is $100. In the next step, when Bob receives this BLT, Bob decrypts it and deposits it in his bank. He does that by creating a BLT with the source set to his bank account, and the destination set to his Bank's enrolled ID and including Alice's decrypted BLT as the payload of this BLT 432. Bob then sends 450 this BLT 442 to his Bank 436. When the bank 436 receives the BLT 442, it notes that the payload is an unencrypted BLT 440. It optionally verifies 444 the BLT 442 with the SVA System by submitting it to the SVA Platform 232. Since the SVA Platform logs all BLTs, it recognizes both the outer BLT 442 sent by Bob, as well as the inner BLT 440 from Alice in the payload and thus is able to verify both BLTs. Once the verification is complete, Bob's bank 436 is ready to accept the BLT 442 the same way as a deposited check. The BLT verification by the SVA System is not really necessary, as both the inner BLT 440 in the payload and the outer BLT 442 are signed by the SVA Platform 232, but this step can provide an additional layer of verification. Once the verification is complete Bob's bank 436 initiates 446 its inbuilt settlement feature with Alice's bank 434, which causes a transfer of $100 from Alice's account in Alice's bank 434 to Bob's account in Bob's bank 436.

Not shown in the figure, but a feasible implementation choice is that Bob's bank 434 and Alice's bank 436 use BLTs for settlement, in which case they will send BLTs to each other with all their customer's deposited BLTs as the payload.

Also not shown in the figure, is that Alice 202 could have chosen to pay via her credit card, in which case the source field of her BLT 440 would have been her enrolled credit card number. In this case, Bob 432 would have directed his BLT to his credit card payment processor rather than his bank, while still including Alice's BLT 440 as the payload. The payment processor would eventually credit Bob's bank account with the amount specified by Alice 202 minus the customary deductions for credit card charges.

An important point to note is that the SVA System verification only verifies the syntactic integrity of the BLT, not its semantic integrity. For example, Alice 202 might not have $100 in her account, and thus her BLT 440 of $100 might not be honored, which is the equivalent of a bounced check. Syntactic verification can only be done with semantic knowledge of the payload, which is application-dependent and outside the scope of the SVA System.

This use case demonstrates the versatility of BLTs in providing a simple digital payment solution that encompasses and unifies all existing payment methods. BLTs provide both simplicity and security, as only Bob 432 can accept Alice's BLT 440 in the first step and only Bob's bank account can get credited in the second step.

FIG. 14C depicts a third use case illustrating the power of BLTs to simply and secure all types of financial transactions. The figure shows how BLTs can be used to negotiate the sale and transfer of arbitrary assets from one user to another in a safe and secure manner.

At the beginning, Bob 432 is the owner of the “alice.com” DNS domain 452 which has been enrolled in the SVA System. Bob 432 advertises this domain for sale. Alice 202 wants to buy this domain. To initiate the buying process, Alice 202 first verifies that Bob is the authorized owner of the domain in the first step by sending 454 a challenge BLT 456 with the source address set to the domain and a random string in the payload. Bob 432, being the legitimate owner of this domain 452, is able to decrypt this BLT 456 and respond 456 to Alice 202 in the second step by sending a BLT 458 with the same random string in the payload. This lets Alice 202 know that Bob 432 is the legitimate owner.

Steps 460 and 462 are monetary offers and counteroffers encoded in BLT payloads. The use of BLTs which are digitally signed, ensures that each step is a valid legal contract if accepted. Alice 2020 likes Bob's offer in step 462 and therefore in step 464, she makes a payment via BLT 466 to Bob 432. In step 468, Bob 432 deposits Alice's payment and transfers the alice.com domain 452 to Alice 202. Before transferring the domain 452, Bob 432 terminates the enrollment of the domain in the SVA System. Alice 202 now enrolls the domain as one of her enrolled identities, thus protecting the domain till Alice 202 chooses to sell or transfer it.

This use case illustrates how BLTs can be used to verify asset ownership, negotiate for ownership of the asset, conclude the sale, transfer ownership and register ownership of the asset. This shows that BLTs are a suitable tool for managing the entire lifecycle of non-fungible assets.

BLTs raise three privacy issues. First, the SVA Platform 232 or the SVA Client 230 gets to see the BLT payload which might be sensitive. This may be solved by encrypting the payload before handing the BLT template to the SVA System and sending the encryption key to the recipient along with the BLT.

Second, there might be leakage of information correlating multiple enrolled identities of a user. For example, consider a user with a public email address: public@example.com and a secret email address: secret@example.com. The user uses the public email address with everyone, but the secret email address only with selected recipients. Assume both email addresses are enrolled identities of this user. Now, if another user, who suspects that the same user is behind both email addresses, creates a BLT with secret@example.com as the recipient, but sends it via email to public@example.com and the user accepts this BLT and responds, then the second user knows that both email addresses are owned by the same user. As a result, users should be careful of accepting BLTs that specify an alternate identity to the one that the BLT was received on.

Finally, a malicious user could potentially see if an identity is in use or not by creating a BLT specifying that identity as a recipient. If the BLT is created, then it indicates that the identity is valid and enrolled in the SVA system and can be subject to a phishing attack. To solve this issue, the SVA system always accepts all recipients in BLT templates without raising any errors. If the recipient identity is not enrolled, then the SVA system generates a fake key corresponding to that user. Of course, such BLTs cannot be decrypted by any user and thus serve no purpose, but they serve to obscure the validity of enrolled identities and thus prevent information leakage about enrolled identities.

One major differentiator between BLTs and regular digitally signed messages is that not only can they not be subject to a bearer-based attack, but also the users and the applications are not involved in the creation and maintenance of their key pairs, or the overhead of obtaining the recipient public keys. All is done automatically and out-of-band and with no involvement of the users and applications beyond the generation and receipt of the BLTs.

BLTs can also be sent and received using any enrolled identity.

Furthermore, as described by the BLT use cases described above, BLTs allow for secure authenticated financial transactions to take place over the internet over a non-real-time messaging channel like email, rather than the traditional web-based application channels. For example a buyer and a seller might enter into purchase negotiations using BLTs to send offers and counter-offers, before agreeing to a purchase price and actually completing the purchase. This level of flexibility and negotiation that is characteristic of human-to-human interaction is not available with the simple “Buy” button of an ecommerce store. Finally, all BLTs are routed by and logged by the SVA Platform 232, providing a third party audit and verification trail for all transactions encoded by the tokens.

Compared to conventional crypto wallets, where the crypto transactions are secured by a single key which can be stolen, the SVA System allows for a MultiSig wallet to be created as an added value-added service where each crypto transaction is protected by at least two separate and independent keys, one at the SVA Client and one at the SVA Platform. The SVA Platform key can only be unlocked if the user is validated using their BLI, thus providing a Bio-locked MultiSig Wallet service. This is illustrated in FIG. 14D.

FIG. 14D illustrates a process for Bio-locking a MultiSig Wallet. Alice 202 may initiate 480 a MultiSig transaction toward Bob 218 using the Wallet built into the SVA Client 230 on Alice's device 206. SVA Platform 232 may then verify that Alice 202 is validated and sends the transaction request 482 to Alice's wallet 470 in the platform which adds its signature to the transaction before forwarding it 484 to Bob's device 220 creating a MultiSig transaction. A copy is transmitted 486 back to Alice's MultiSig Wallet 472 on Alice's device 206. Unlike conventional cryto transaction, the MultiSig transaction cannot be hacked because it requires Alice's device to sign the transaction and the wallet platform to also sign the transaction. This allows users to send and receive MultiSig digital wallet and cryptocurrency transactions that are bio-locked to the sender and receiver.

As mentioned above regarding SVA identities, the SVA System itself does not provide any visible identities to users to identify other users or devices. However, users need a mechanism to identify other users, for example to mark a user as a validator. This issue of user and device identification is solved using a pairing process that works similar to the way Bluetooth devices are paired. When two users seek to identify each other, for example, when a user wishes to configure another user as a validator, then the first user generates a random number and the second user generates a second random number. By exchanging these two random numbers with each other, as well as the SVA Platform 232, it is possible for the SVA Platform 232 to associate the two users together with the first being the validatee and the second user the validator. Once the association is made, each user may use a nickname to refer to the other user, e.g. “John” or “Son”. The SVA Client 230 generates the random numbers at each end, and it is the responsibility of the users to communicate the numbers to each other through an out-of-band manner and then input the received random number in the SVA Client 230. Pairing is complete when both users have input the remote numbers correctly.

Pairing is used extensively in the SVA Authentication scheme: linking validators and validatees, linking additional devices to a user, linking application login to users (using OTP as random number), in adding users to a shared account, and in the validation process itself.

The basic operation of the SvaSys 200 has been discussed and the features designed to make the system more resilient and usable will now be discussed.

The SvaSys 200 relies on human validators to validate and authenticate other users. However, humans can be quite unreliable and therefore resilience requires that multiple validators be configured for each user.

Being human, it is not reasonable to expect a validator to be available at all times, such as when sleeping or at work or on vacation. Thus the SVA Client 230 displays the validator state, which may be set to either available or not available, on a per-validatee basis. A user can only validate with validators marked as available.

Not all validators are created equal. Friends and family with whom we interact on a daily basis are more suited to validation than occasional acquaintances. However, occasional friends are useful in emergencies when close friends and families are not available. While a single close family member may provide validation to a user, it might be better to be validated by multiple distant acquaintances to provide resilience against authentication mistakes from a single casual acquaintance. A solution in the SvaSys 200 may be to let a user assign each validator a score, with the total score across all validators needing to exceed a threshold value, such as for example 100, for successful validation. Furthermore, if a validator is not currently validated, then that validator score may drop to half its original score. This helps prevent attacks from idle devices.

The validation time is the time the user has been validated so far. A user may configure the maximum validation time before validation expires, for example 26 hours, which allows the user to be validated once a day. However, an application may also specify a validation timeout. For example, a highly secure application, for example for opening a bank vault, can specify a validation timeout of a few seconds to force validation before each use. Similarly, a bank application may specify a validation timeout of a few seconds to force a validation in the middle of a session to validate a high value transaction.

While the SVA Platform 232 is ideal for validation in a large home environment, where the home members can validate each other in an air-gapped manner at home on a daily basis, not all users fit such a profile. There are other users who live solitary lives without interaction with other humans, and it will be difficult for such people to find reliable and trustworthy human validators. In such cases, self-validation is a solution. Here the user needs two devices and two identities configured on the two devices with one identity validating the other. Such a solution requires physical security of the second device to prevent denial of service. Self validation is also a good solution for general users who are looking for a backup solution to deal with emergency scenarios.

While the SVA system is itself very secure, it is possible that a device with an authentication SVA Client 230 can fall into malicious hands if the device pin code or biometrics is compromised. In that case the malicious user will have access to the full user capability as long as the validation timeout has not been exceeded. To prevent the malicious user from changing the validators of this account from the original validators to those under the malicious user's control, the SVA system does not execute the delete validator command immediately but notifies the validator immediately and then deletes the validator after a day. This gives the validator and the user the chance to notice the missing device and to use the validator lock privilege to lock the offending device.

So far SVA authentication has been described in the context of individual users accessing Internet-based applications and services. The same principles apply to enterprise use cases as well. It is possible to use the SVA System for the enterprise as well with some changes as noted below.

Each enterprise has its own identity space, which is distinct from other enterprises and individual users. As a result, each SVA enterprise network is completely different and isolated from the personal SVA System.

An enterprise user will have a SVA enterprise client, which connects to the SVA enterprise platform. For enterprise users the validators may be senior managers and supervisors. There is no self-validation, except for the head of the enterprise. There is no account sharing. There is also no enrollment of external identities, but corporate identities such as email addresses are allowed, allowing SVA Enterprise users to send bio-locked messages to others within the enterprise. While a user can have only one SVA Client application for personal identity management, the same user can have multiple SVA Enterprise client applications-one for each enterprise the user belongs to. Typically enterprises have an Identity and Access Management (IAM) system already in place. SVA enterprise will coexist or supplant the Identification aspect of identity management but will not affect any of the other features of the IAM system. The IAM system will, after successful authentication of the enterprise user, allow the user to assume one of the potentially many roles that the user has to access enterprise resources.

The SVA Client 230 is a software application designed to run on a variety of end user devices like phones, tablets and personal computers. The minimum requirements for the SVA Client 230 is a secure key store, and a reasonably good way of locking applications. The SVA Client 230 will survive key loss, but it is still preferable to minimize the probability by having a device with a secure key store, for example a secure enclave. Note that while the SvaSys does not make use of passwords or device biometrics, it is expected that the SVA Client 230 is protected from unauthorized access by a device specific pin code or password or device biometrics.

The SVA Client 230 only communicates with the SVA Platform 232. On initial install, the SVA Client 230 fingerprints the device and creates a device key pair and sends the fingerprint and public key to the SVA Platform 232, which lets the SVA Platform 232 associate the device with the client. The SVA Client 230 also signs all messages with the private device key, together with a message count and a timestamp. Any skips in the message count creates an alert for the user. The timestamp is derived from the SVA platform's clock, allowing SVA Clients 230 to operate independent of local clocks. The SVA Client 230 uses a menu to display the list of user services.

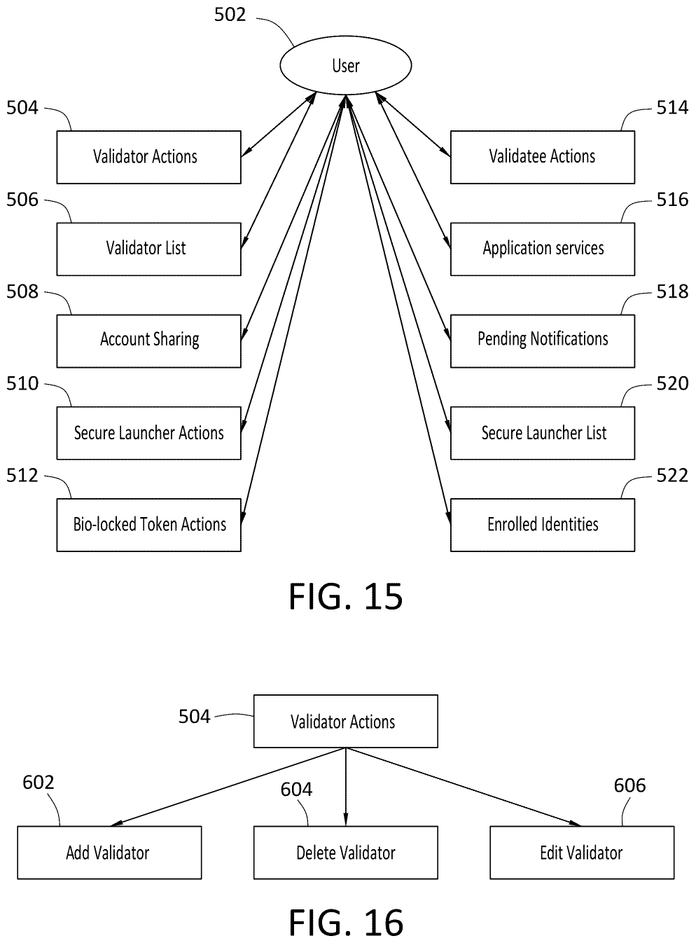

FIG. 15 illustrates a list of user services that might appear in a menu. The user 502 may select from validator action 504, validator list 506, account sharing 508, secure launcher actions 510, bio-locked token actions 512, validatee action 514, application services 516, pending notification 518, secure launcher list 520, and enrolled identities 522.

FIG. 16 illustrates a menu of items associated with validator actions tab. The add validator tab 602 initiates the basic first step towards setting up and using the SVA Authentication. This initiates the pairing process with the other user, who uses the validatee tab 514 to complete the pairing. Once a validator is added, the validator parameters such as the validator score and privileges can be added. As mentioned earlier, the sum of validator scores need to exceed a threshold value (e.g., 100) for successful validation. Configurable validator privileges include lock privilege (if that validator can lock this device and prevent authentication from this device) and add device privilege, which allows the validator to sign in a new device for this user if the user were to lose this device. These are sensitive privileges that allow users to recover quickly from lost or stolen devices but must only be given to trusted people. The validator score is not visible to the validators, but the privileges are. Once a validator is added, the validator is visible in the validator list tab 506 and may be used for validation if available.

The delete validator tab 604 is used to delete a validator. Once a validator is removed, the validator is removed from the validator list tab 506. It is the responsibility of the user to ensure that the scores assigned to the remaining validators is above 100. If the validator was the only one with any lock or device add privileges, the user might consider adding these privileges to another validator. As mentioned earlier, to prevent a malicious user with access to this device from deleting the existing validators, the delete validator command only takes effect after 24 hours, while immediately notifying the validator. This gives the validator and the user a chance to lock the original device if it has been stolen or is in malicious hands.

The edit validator tab 606 allows users to change validation score as well as lock privilege and add the device privilege.

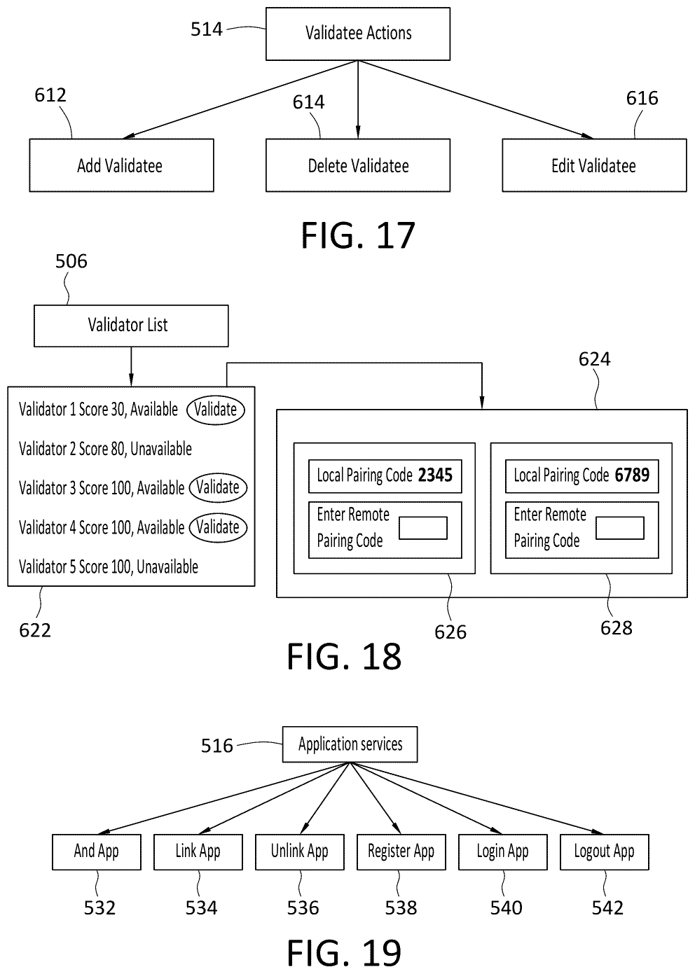

FIG. 17 illustrates a menu of items associated with validatee actions tab 514. The add validatee tab 612 and delete validatee tab 614 are symmetric to the add/delete validator services described above, but from the perspective of the validator. The edit validatee tab 616 sets a state to available or not. This can be done globally as well as on a per-validatee basis.

FIG. 18 illustrates a menu of items associated with the validator list tab 506. The list of configured validators tab 622 includes a list of vaildatees and shows their nicknames and if they are available or not. Clicking on any one of the available names starts the validation process for authenticating this user.

When the validate icon next to a name in the validator list is clicked, the validation process is launched 624. The corresponding validator is notified on his/her SVA Client 230 application that this particular validatee secks validation. A random number appears in each screen 626 and 628. This initiates an out of band communication between the validator and validatee and results in deep biometrics based identification or rejection of the validatee by the validator. When the validator recognizes the validatee, then both users exchange the random numbers present on their screen 626 and 628. If both numbers are input correctly, the pairing is successful and the validation by this validator is complete and the time is noted. If the validator score is less than a threshold value of, for example, 100 and the total validation score is less than 100, then the user needs to contact more validators to push the score to beyond 100.

FIG. 19 illustrates the application services tab. The application services tab 516 includes the add application tab 532, link application tab 534, unlink application 536, register application tab 538, login application tab 540, and the logout application tab 542.

If the user already has a pre-SVA account in the application, the user needs to log into the application using the pre-SVA credentials and then choosing the link application tab 534 in the application services tab 516 to link the application to the user SVA bio-locked identity. This opens an authentication page that the user can populate with the OTP received from the SVA Client 230 for this app. Successful linking will associate the SVA Client 230 and SVA Platform 232 key pairs for this user with the application back-end. This will permit direct SVA based login into the application.

The unlink application tab 536 unlinks and deregisters the application from SVA bio-locked identity and deletes the key pairs at the SVA Client 230 and SVA Platform 232. This action may or may not delete a user from the application, based on application settings.

The register application tab 538 is very similar to the link application feature. This creates a new key pair at the SVA Client 230 and SVA Platform 232 and generates an OTP for the user to register and login and create a new SVA-based account. The application registration screen might take some added inputs, such as the user details and personal information.

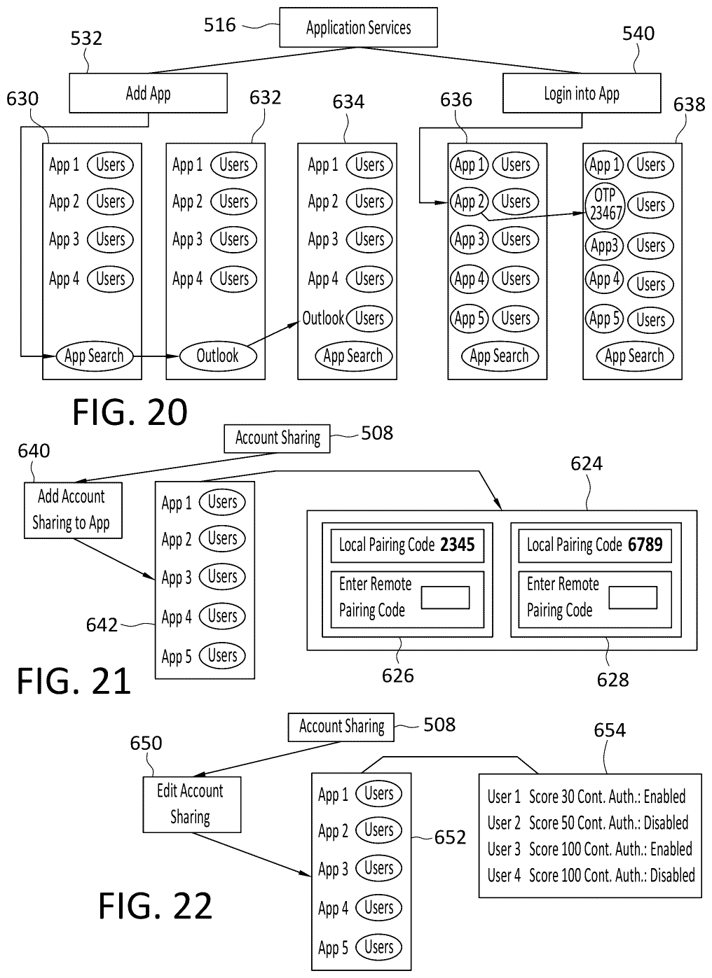

FIG. 20 illustrates the add application tab and login to application tab in more detail. A list of applications 630 is displayed with a search function. When the user selects the application search button, a new display 632 is shown listing the application Outlook. If Outlook is selected, the display is updated to 634 showing Outlook as one of the applications.

The login into application tab 540 displays the list of configured apps 636. Clicking on an application icon displays an OTP for login 638 unless account sharing (described below) is configured. Note that the user needs to launch the application separately and fill the initial application login prompt with this OTP, unless the secure launcher feature described below is configured, which does this step automatically. When sending the OTP to the application, along with the SVA Client 230 and platform signed authentication request, the SVA Client 230 may also send metadata about the client environment, such as GPS and device characteristics.

If Account Sharing is configured for this account and the score of this user is insufficient to log into the application directly, then clicking on the application icon will not display the OTP. Clicking on a shared account application icon will instead display icons of the other identities sharing this account and their scores. Clicking on an identity icon will send an authentication request to the SVA Client 230 of that user requesting them to log into this account. Then when sufficient users respond to that authentication request such that the scores of the responding users exceeds a threshold value (i.e., 100), this user is presented the OTP for logging into this application. Similar to validators, only the icons of available users is highlighted and only the available users can respond to the authentication request from this user.

The logout from application tab 542 indicates to the application through the bio-locked channel that the user is no longer logged in. While it is possible to logout from the application screen, this option is useful if the application is hanging, or on a remote device which is hanging.

The account sharing tab 508 may include an add account sharing to application tab 640, edit account sharing tab 650, join account sharing application 660, FIG. 22 illustrates account sharing tab 508. Account sharing allows for flexibly sharing a single application account across multiple SVA users in a way that is transparent to the application.

FIG. 21 illustrates the add account sharing to application tab. This add account sharing to application tab 640 will configure account sharing to an application with a preexisting non-shared account. Here the user can select an application from the list of existing apps. Once the application is selected, then the user sees a tab listing the applications 642. When the user selects the list of users associated with an application, validation process 624 is launched. Then the process of pairing different users using random numbers that are exchanged to indicate pairing consent 626 and 628. The primary user will use the Add Users icon to generate his random number, while the secondary users will use the Join Account Sharing icon to generate their random numbers. In addition to the random number, this tab also allows the primary user to set the score of the secondary user and assign a nickname. Once the pairing is done, this user is added to the user list that is displayed whenever any user of the shared account clicks on the Login into application tab. All shared account users will see the application and its associated user list and per-user score, though only the primary user can edit it.

FIG. 22 illustrates the edit account sharing application tab. The edit account sharing application tab 650 allows the primary user to select a shared application from the list of shared applications 652 and edit the users as well as their scores 654. Also, each of the users may have the ability to support continuous authentication enabled or disabled. Once all users are deleted, the account switches from a shared application to a regular single user app.

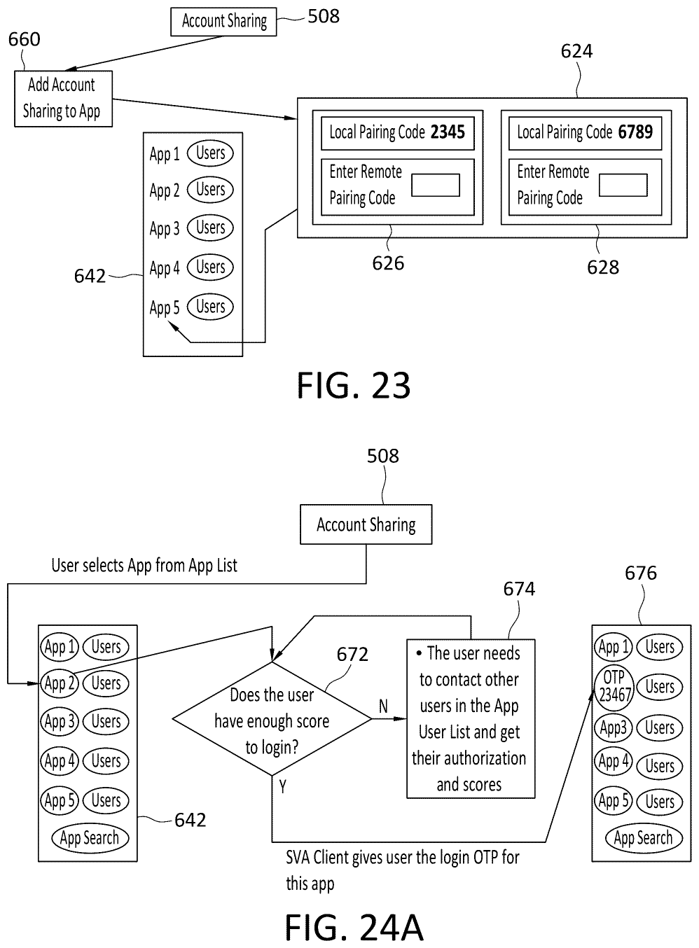

FIG. 23 illustrates the join account sharing application tab. The join account sharing application tab 660 is used by secondary users to join a shared account. The secondary users exchange the random number obtained on this screen 624 with the primary user to complete the account sharing process for the secondary user 626 and 628. From this point onward, the application is added to the list of applications of the secondary user and the secondary user can also log into the application using the primary user's credentials. Of course, successful login will require authentication not only from this secondary user, but also agreement from other users if this user's score is less than that a threshold value (e.g., 100)

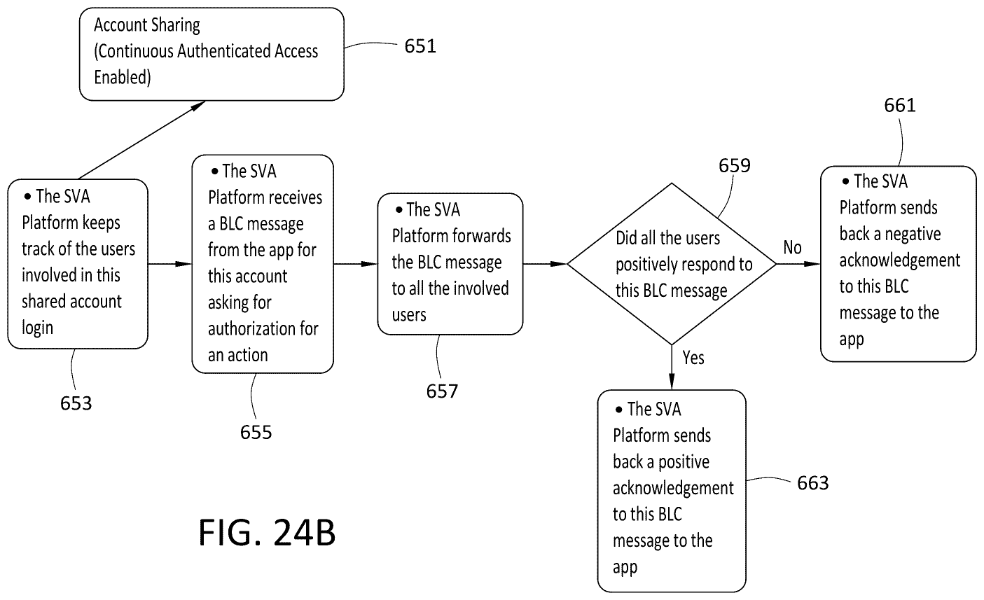

FIG. 24A illustrates a user selecting an application and logging in. First the list of applications is presented 642. The user selects one of the applications. Then it determines if the user has a high enough score to login 672 based upon validations. If not, the user then needs to contact other users in the application user list and obtain additional authorizations 674. Then the score is checked again 672. Once the user has a sufficiently high score, the SVA Client generates the OTP to be used to log in 676.

FIG. 24B illustrates the flow for continuous authenticated access to a shared account. At step 651 account sharing is enabled for other others. At step 653 the SVA platform 232 keeps track of the users associated with the shared account. The SVA platform 232 then may receive a BLC message from the application for this account secking authorization for an action 655. Next, the SVA platform 232 forwards the BLC message to all the involved users 657. Next, the SVA platform 232 determines if all of the users responded positively to the BLC message 659. If so, then the SVA platform 232 sends back a positive acknowledgement message to the application that acknowledges the received BLC message 663. If not, then the SVA platform 232 sends back a negative acknowledgement message to the application that does not acknowledge the received BLC message 661. It noted that a subset of the users may be enough to acknowledge the BLC message and the users may be weighted in their ability to acknowledge a message. In this case a weighted value must be reached to acknowledge the BLC.

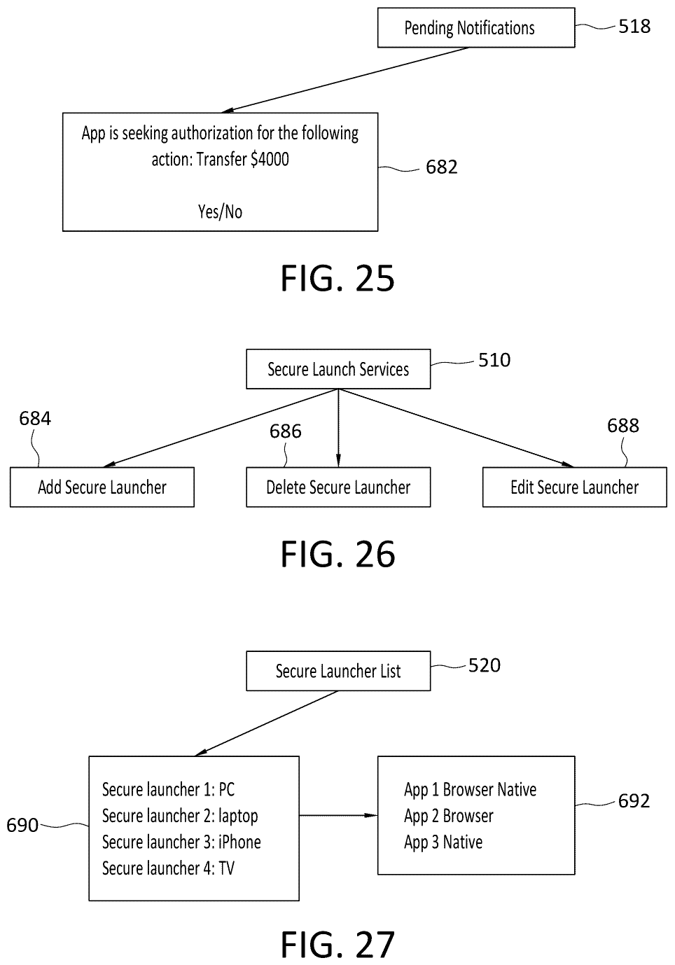

FIG. 25 illustrates the pending notifications tab. The pending notifications tab 518 displays the existing list of notifications from the application seeking user authentication over the bio-locked channel for some user action in the application. The user can respond with either yes or no. For example, a notification that the application is seeking authorization for the transfer of $4000 682. In addition, if an application is configured for account sharing, this authentication request may originate from a user trying to login in without a sufficient score to login. Responding with a yes will add the responding user's score to that of the user trying to login.

FIG. 26 illustrates the secure launch services tab 510. As discussed in previous sections, the secure launch service allows one-click launch of logged in applications without the need to manually type in the OTP. The secure launch services tab 510 then displays an add secure launcher tab 684, a delete secure launcher tab 686, and an edit secure launcher tab 688.

The user needs to first download the secure launch application for the specified platform and install it manually. Clicking on the add secure launcher tab 684 initiates a pairing process to link the launcher to the SVA Client. Once the pairing is complete the SVA Client retrieves the device fingerprint from the launcher. If it is the same as the local device fingerprint, then the SVA Client does nothing, as it is a local launcher. But if the device fingerprint is different, then the SVA Client and the SVA Server create separate key pairs for the secure launcher device for each app. After adding a secure launcher, it appears in the secure launcher list tab 520.

The delete secure launcher tab 686 removes the device specific key pairs associated with this secure launcher if on a remote device and deletes the launcher from the secure launcher list tab 520.

The edit secure launcher tab 688 allows the user to access user configurable parameters such as a short name, like “PC” or “Phone”, the preferred launch browser for browser based applications, and any additional configuration parameters, such as preferred size and geometry.

FIG. 27 illustrates the secure launcher list tab. The secure launcher list tab 520 enumerates the different devices 690 having secure launchers configured. A user may click the secure launch button next to a secure launcher to put up a menu of available applications 692. Selecting any of the applications will launch the application in the device the Secure Launcher is running with the OTP needed for login supplied automatically by the SVA Client.

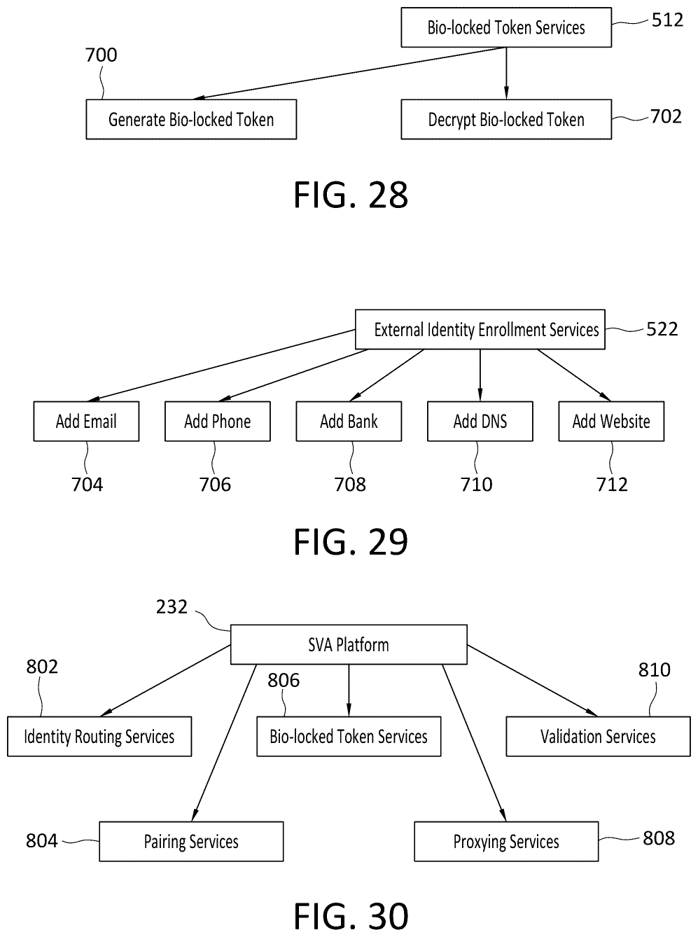

FIG. 28 illustrates the BLT services tab. The BLT services tab includes the generate BLT tab 700 and the decrypt BLT tab 702.

The Generate BLT tab 702 leads to a menu with three fields: the source identity field, destination identity field, and the payload field. The source identity field is filled from one of the enrolled identities, the destination identity field needs to be manually filled, and the payload field is either filled manually or read from a file. The output is a file containing the BLT, which can then be sent as an attachment over any communications channel such as email or MMS. In case the target user has multiple devices, then there are multiple possible devices that may be selected.

The decrypt BLT tab presents a menu that takes a file as input and if the file contains a valid BLT with the destination identity set to one of the enrolled identities, then the function will decrypt the BLT and restore the original contents, allowing the user to see the authenticated sender identity and the payload.

FIG. 30 illustrates the external identity enrollment services tab. The external identity enrollment services tab 522 includes the add email tab 704, the add phone tab 706, the add bank tab 708, the add DNS 710 tab, and the add website tab 712. The external identity enrollment services tab allows the user to add external identities which may be used for sending and receiving BLTs. Adding an external identity requires verification via proof of ownership. The following proof of ownership tests are performed for each type of identity. The add email tab 704 is used to verify contents of email sent to this address. The add bank account tab 708 is used to verify payments sent to this account. The add phone tab 706 is used to verify a phone conversation over this phone. The add DNS tab 701 is used to create a custom TXT Record for this domain with the specified text. The add website tab 712 is used to create a custom URL for this website.

FIG. 30 illustrates a diagram of the SVA Platform 232. The SVA Platform 232 is the central entity in the SvaSys and is responsible for overseeing and validating all network communication within the SvaSys. All SVA Clients 230 and all application back-ends are connected to the SVA Platform 232 and only communicate with it. The SVA Platform 232 itself does not originate any messages, but is responsible for routing all messages, validating them, and if necessary, augment the messages by adding an extra platform signature.

The SVA Platform 232 performs the following services: identity routing services 802, pairing services 804, BLT services 806, proxying services 808, and validation services 810.

The identity routing services 802 route messages between validators, validatees, enrolled user identities and applications based on the identity of recipients. The SVA Platform 232 keeps track of the state and location of each SVA Client and application back-end. While the application back-end is assumed to have a secure connection that is always available, the SVA Clients are expected to connect only intermittently on demand.

The pairing services 804 allow users to identify other uses via pairing. Pairing is also used to associate OTPs in application logins with SVA users. Each pairing message is checked to see if an existing pairing message in the pending pairing message queue matches it and if so, the pairing is complete. If not, the message is added to the pairing message queue, where it is either matched or discarded after a specified period of time.

The proxying services 808 maintain a state of the SVA Client to allow multiple SVA Clients of a user to sync to the same state. The proxying also allows SVA Clients to communicate with each other, for example, during validation, even when behind network address translators (NATs).

The validation services 810 keep track of the state of validation of each user and each SVA Client. Based on the state of validation, the SVA Platform 232 either endorses or blocks authentication requests from the users. Endorsing the authentication requests includes using the platform keys which provides the second step of validation that protects from client key loss.

The BLT services 806 provided by the SVA Platform 232 allows applications to generate BLTs targeting specified SVA users. These tokens can only be decrypted by the specified user, as they are encrypted with the user's SVA Client's public key. In the reverse direction, the SVA Platform 232 allows applications to receive and decrypt and verify BLTs originating from enrolled identities.

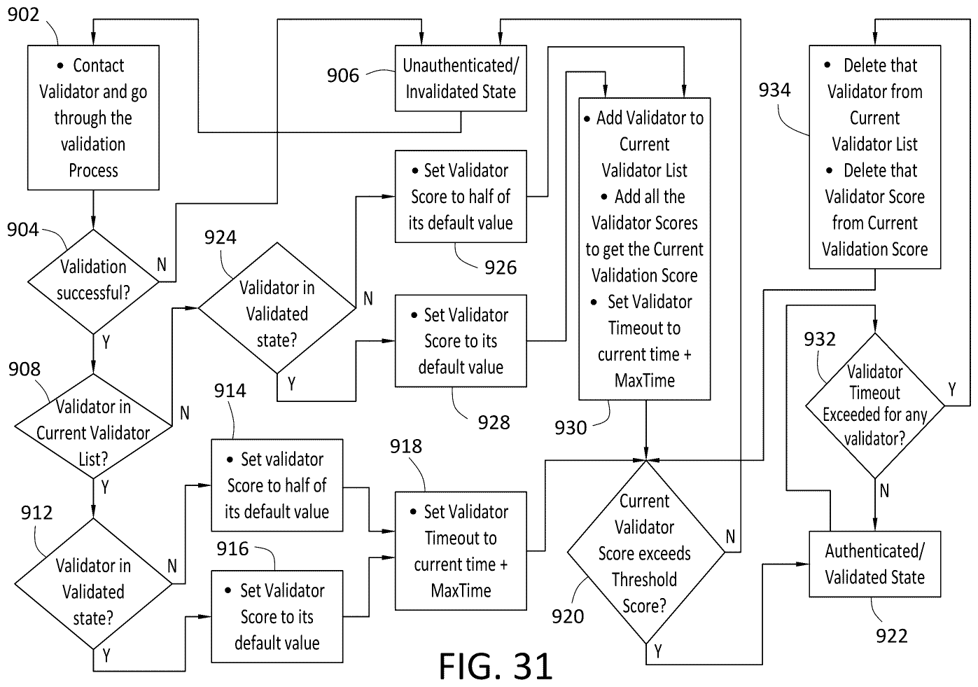

FIG. 31 illustrates a validation logic flow chart. At step 902 the user contacts a validator and goes through the validation process. This validation process may be as described above where the validator and user use an out of band communication to verify the user identity based upon, for example, personal knowledge of the user. At step 904 it is determined if the validation is successful. If not, then the user is unauthenticated and put in an invalidated state 906. Then the process may return to step 902. If the validation is successful, at step 908 it is determined if the validator is in the current validator list. If not, then at step 924 it is determined if the validator is in a validate state. If not, then at step 926 the validator score is set to half its default value. Then at step 930 the validator is added to the current validator list, all the validator scores are added to get the current validation score, and the validator timeout is set to the current time plus the maximum time. If the validator is not in a validated state, then at step 928 the validator score is set to its default value and step 930 is carried out as described above.

After step 930, at step 920 it is determined if the current validator score exceeds a threshold score. If not, then the user is put into an invalidated state at step 906 as before. If the current validator score does exceed the threshold score, then user is placed in an authenticated and validated state 922.

If at step 908, the validator is not in the validation list, then at step 912 it is determined if the validator is in a validate state. If not, then at step 914 the validator score is set to half its default value. Then at step 918 the validator timeout is set to the current time plus the maximum time. If the validator is not in a validated state, then at step 916 the validator score is set to its default value and step 918 is carried out as described above. Next, step 920 is performed as described above.

If the current validator score exceeds the threshold score, then at step 922 validator timers for each validator are monitored, and at step 932, it is determined if a validator timeout is exceeded for any validator. If so, then at step 934 a user may seek to delete a validator from the current validator list and then delete the associated validator score from the current validation score. Then step 920 is performed as described above.

If the validator times has not exceeded the validator timeout for any of the validators, then the user remains authenticated and validated 922.

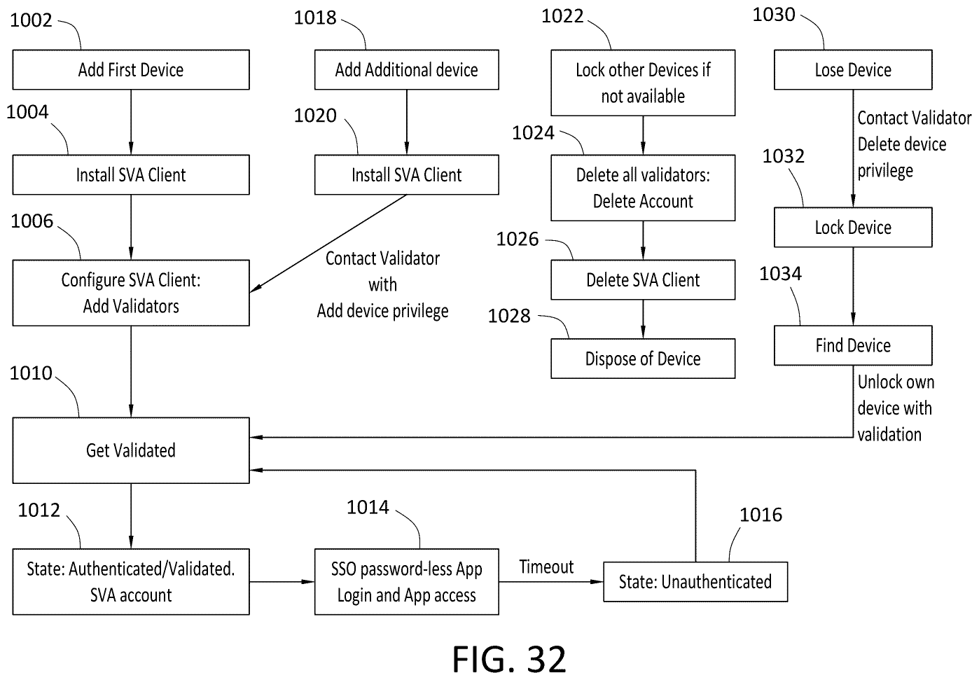

FIG. 32 illustrates a flow diagram of the user and device life cycle. At step 1002 a first user device is added. Then at step 1004 the SVA Client is installed on the user device. Then at step 1006 the SVA Client is configured and the user may add validator. Then at step 1010 the user gets validated by validator(s) as described above. Then at step 1012 the user is in a authenticated and validated state for the SVA account. At step 1014 a single sign on (SSO) password-less application login in is performed to provide application access. This may be accomplished as described above. If a timeout time is reached for the user authorization, then at step 1016 the user's state becomes unauthenticated, and then step 1010 is repeated as described above.

At step 1018 a user may seek to add an additional device. At step 1020 the SVA Client is installed. The step 1006 then is performed as described above to configure the SVA Client and to add validators.

In order to delete a SVA account, at step 1022 other devices are locked if not available. At step 1024 all validators and the account are deleted. Then at step 1026 the SVA Client is deleted from the device. At step 1028 the device may be disposed.

At step 1030 a user may lose a device. The user may then contact a validator with delete device privileges and request that the device be locked at step 1032. At step 1034 the user finds the locked devices and unlocks the device with its own validation steps. Then step 1010 is performed to get validated again.

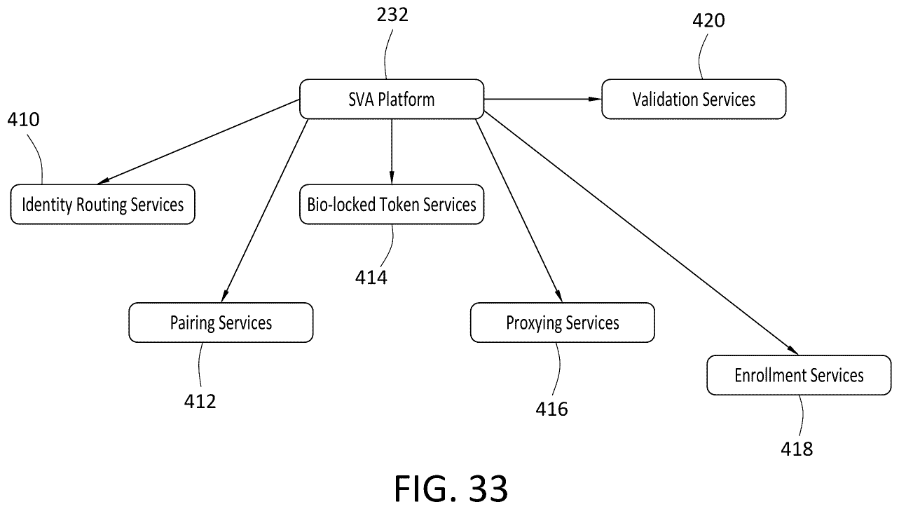

FIG. 33 illustrates the architecture of the SVA platform 232. The SVA platform 232 includes identity routing services 410, paring services 412, BLT services 414, proxying services 416, enrollment services 418, and validation services 420. The identity routing services 410 route messages between validators, validatees, enrolled user identities and applications based on the identity of recipients. The SVA Platform keeps track of the state and location of each SVA Client 230 and Application back-end. The paring services 412 Allow users to identify other uses via pairing. Pairing is also used to associate OTPs in application logins with SVA users. Each pairing message is checked to see if an existing pairing message in the pending pairing message queue matches it and if so, the pairing is complete. If not, the message is added to the pairing message queue, where it is either matched or discarded after a specified period of time.

BLT services 414 provides services related to BLTs. The SVA Platform allows applications to generate BLTs targeting specified SVA users. These tokens can only be decrypted by the specified user, as they are encrypted with the user's SVA Client's public key. In the reverse direction, the SVA Platform 232 allows applications to receive and decrypt and verify BLTs originating from enrolled identities.

The proxying services 416 maintain a state of SVA Client 230 to allow multiple SVA Clients 230 of a user to synchronize to same state. The proxying also allows SVA Clients 230 to communicate with each other, for example, during validation, even when behind NATs.

The enrollment services 418, as described above, validate external identities (like emails and phone numbers) provided by users and maintain an association between the enrolled identities and the SVA BLI of a user and these Enrolled identities. The validation services 420 keep track of the state of validation of each user and each SVA Client 230. Based on the state of validation, either endorse or block authentication requests from the users. The insecure connection 214 endorses using the Platform keys which provides the second step of validation that protects from client key loss.

Various embodiments may further include Quantum-Safe operations with key rotation based on multiple keys. Each entity in a SVA System, such as the SVA Client, the SVA Platform and the Application Server can store not just a single public-private key pair for pair wise communication, but multiple public-private key pairs. This allows for key rotation, support for multiple key algorithms, and replacement of existing key generation algorithms with Quantum-Safe algorithms as necessary.

As an example, JSON (JavaScript Object Notation) is a known standard for sending and receiving data over the Internet. A JSON Web Token (JWT) is a standard for sending and receiving digitally signed and encrypted JSON messages over the Internet. To send JWTs, peers exchange public keys with each and associate each key with a unique Key Identifier (KID). So each public-private key pair is now associated with a KID, since the private key has the same KID as the public key. The KIDs can be assigned centrally or in a distributed fashion as long as each public-private key pair is associated with a unique KID.

Take the case when the SVA Client and the SVA Platform each generate 3 public-private key pairs and exchange their 3 public keys. Assume that the keys are assigned KIDs 1 to 6. Now if the SVA Client wants to send a digitally signed and encrypted message to the SVA Platform, then the SVA Client will select one of its private keys, for example, the private key with KID 2, and sign the message. It will then encrypt the signed message with one of the public keys of the SVA Platform, say key 4. The actual JWT that is sent consists of the signed and encrypted message, along with the signing KIDs 2 and the encrypting KID 4 in the cleartext metadata of the JWT.

At the SVA Platform end, when the JWT is received, the SVA Platform sees that the JWT is encrypted using KID 4, so it uses the private key corresponding to KID 4 to decrypt the encrypted message and uses the public key corresponding to KID 2 to verify the JWT was actually signed by KID 2.

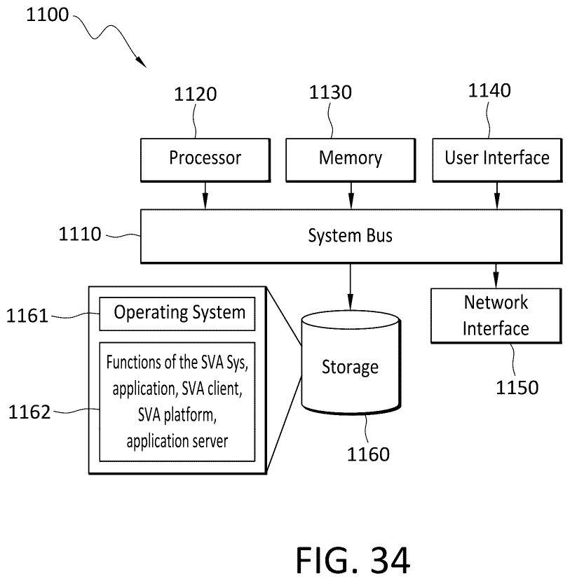

The use of KIDs greatly simplifies the JWT processing at the receiving end, since it removes the guesswork of trying to figure out which key out of many possible keys were used to sign and/or encrypt the JWT message. FIG. 34 illustrates an exemplary hardware diagram 1100 for implementing the SVA System, client secure component 230, application 208, the application server 212, the SVA Platform 232. The exemplary hardware 1100 may correspond to one or more user device 206, user device 220, application server 212, and SVA Platform 232. As shown, the device 1100 includes a processor 1120, memory 1130, user interface 1140, network interface 1150, and storage 1160 interconnected via one or more system buses 1110. It will be understood that FIG. 32 constitutes, in some respects, an abstraction and that the actual organization of the components of the device 1100 may be more complex than illustrated.

The processor 1120 may be any hardware device capable of executing instructions stored in memory 1130 or storage 1160 or otherwise processing data. As such, the processor may include a microprocessor, microcontroller, graphics processing unit (GPU), neural network processor, field programmable gate array (FPGA), application-specific integrated circuit (ASIC), or other similar devices. The processor may be a secure processor or include a secure processing portion or core that resists tampering.

The memory 1130 may include various memories such as, for example L1, L2, or L3 cache or system memory. As such, the memory 1130 may include static random-access memory (SRAM), dynamic RAM (DRAM), flash memory, read only memory (ROM), or other similar memory devices. Further, some portion or all of the memory may be secure memory with limited authorized access and that is tamper resistant.

The user interface 1140 may include one or more devices for enabling communication with a user. For example, the user interface 1140 may include a display, a touch interface, a mouse, and/or a keyboard for receiving user commands. In some embodiments, the user interface 1140 may include a command line interface or graphical user interface that may be presented to a remote terminal via the network interface 1150.

The network interface 1150 may include one or more devices for enabling communication with other hardware devices. For example, the network interface 1150 may include a network interface card (NIC) configured to communicate according to the Ethernet protocol or other communications protocols, including wireless protocols. Additionally, the network interface 1150 may implement a TCP/IP stack for communication according to the TCP/IP protocols. Various alternative or additional hardware or configurations for the network interface 1150 will be apparent.

The storage 1160 may include one or more machine-readable storage media such as read-only memory (ROM), random-access memory (RAM), magnetic disk storage media, optical storage media, flash-memory devices, or similar storage media. In various embodiments, the storage 1160 may store instructions for execution by the processor 1120 or data upon with the processor 1120 may operate. For example, the storage 1160 may store a base operating system 1161 for controlling various basic operations of the hardware 1100. The storage 1162 may include instructions for carrying out the functions of the SvaSys, application 208, authentication SVA Client 230, application server 212, and SVA Platform 232.

It will be apparent that various information described as stored in the storage 1160 may be additionally or alternatively stored in the memory 1130. In this respect, the memory 1130 may also be considered to constitute a “storage device” and the storage 1160 may be considered a “memory.” Various other arrangements will be apparent. Further, the memory 1130 and storage 1160 may both be considered to be “non-transitory machine-readable media.” As used herein, the term “non-transitory” will be understood to exclude transitory signals but to include all forms of storage, including both volatile and non-volatile memories.

The system bus 1110 allows communication between the processor 1120, memory 1130, user interface 1140, storage 1160, and network interface 1150.

While the host device 1100 is shown as including one of each described component, the various components may be duplicated in various embodiments. For example, the processor 1120 may include multiple microprocessors that are configured to independently execute the methods described herein or are configured to perform steps or subroutines of the methods described herein such that the multiple processors cooperate to achieve the functionality described herein. Further, where the device 1100 is implemented in a cloud computing system, the various hardware components may belong to separate physical systems. For example, the processor 1120 may include a first processor in a first server and a second processor in a second server.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method for detecting by a user device a cybersecurity threat in a secure virtualization authentication (SVA) System, comprising:
obtaining application side TLS parameters from a client application;
obtaining application server side TLS parameters using a bio-locked channel;
comparing the application side TLS parameters with the application server side TLS parameters; and
determining that a cybersecurity threat exists if the application side TLS parameters do not match the application server side TLS parameters.

2. The method of claim 1, further including establishing the bio-locked channel between an SVA client on the user device and an SVA platform to obtain the application side TLS parameters.

3. The method of claim 2, further including establishing the bio-locked channel further between the SVA platform and an application server corresponding to the client application, and the bio-locked channel is used to obtain the application side TLS parameters.

4. The method of claim 1, wherein the bio-locked channel uses a bio-locked identity of the user of the user device to sign messages including public and private keys.

5. The method of claim 4, further comprising associating a first key pair with the user at a SVA Client.

6. The method of claim 5, further comprising associating a second key pair with the user at the SVA Platform.

7. The method of claim 6, wherein bio-locked identity uses a plurality of public-private key pairs.

8. The method of claim 7, wherein the bio-locked identity employs key rotation of the plurality of public-private key pairs.

9. The method of claim 1, wherein the cybersecurity threat is a man-in-the-middle attack.

10. The method of claim 1, wherein the bio-locked channel uses bio-locked tokens to bio-lock the identity of the user of the user device.

11. A method of mitigating a cybersecurity threat in a secure virtualization authentication (SVA) System, comprising:
generating session TLS parameters TLS1 by an application server;
transmitting TLS parameters TLS1 using a bio-locked channel to an SVA platform;
transmitting, by the SVA platform, the TLS parameters TLS1 to an SVA client on a user device;
forwarding, by the SVA Client, TLS parameters TLS1 to an application on the user device; and
initiating, by the application, a TLS session with the application server using TLS parameters TLS1 without parameter legitimation over the Internet.

12. The method of claim 11, further including establishing the bio-locked channel between an SVA client on the user device and an SVA platform to obtain the application side TLS parameters.

13. The method of claim 12, further including establishing the bio-locked channel further between the SVA platform and an application server corresponding to the client application, to obtain the application side TLS parameters.

14. The method of claim 11, wherein the bio-locked channel uses a bio-locked identity of the user of the user device to sign messages including public and private keys.

15. The method of claim 14, further comprising associating a first key pair with the user at a SVA Client.

16. The method of claim 15, further comprising associating a second key pair with the user at the SVA Platform.

17. The method of claim 16, wherein bio-locked identity uses a plurality of public-private key pairs.

18. The method of claim 17, wherein the bio-locked identity employs key rotation of the plurality of public-private key pairs.

19. The method of claim 11, wherein the cybersecurity threat is a man-in-the-middle (MITM) attack and the MITM is only exposed to encrypted traffic.

20. A method of bio-locking entities in a secure virtualization authentication (SVA) System using enrolled identities, comprising:
maintaining by an SVA platform a registry of users;
associating with each user in the registry, one or more enrolled identities; and
associating with each enrolled identity, a key pair to be used to for bio-locked communications.

21. The method of claim 20, wherein the enrolled identities comprise digital user assets including one of email addresses, phone numbers, websites, random numbers and hashes.

22. The method of claim 20, further comprising associating each enrolled identity with a key pair at a SVA Client of the user and a key pair at the SVA Platform.

23. The method of claim 22, wherein the private key operations like signing and decryption at the SVA Platform is only available for validated users.

24. A method of performing a multi-signature transaction in a secure virtualization authentication (SVA) System using enrolled identities, comprising:
initiating a multi-signature transaction by a first user device toward a second user device using an SVA client on the first user device by sending the transaction request to the SVA Platform;
verifying, by an SVA platform, that the identity of the first user device is validated and, if validated;
adding signature to the transaction request and forwarding the signed transaction request to the second user device.

25. The method of claim 24, wherein the transaction request transmitted from the SVA client to the SVA platform.

26. The method of claim 25, wherein the transaction request uses a bio-locked token.

27. The method of claim 24 wherein the multi-signature transaction is initiated by a first digital wallet on the SVA client of the first user device, the first digital wallet signing the transaction request, and after the SVA platform verifies the identity of the first user device, the SVA platform sends the transaction request to a digital wallet platform associated with the digital wallet, the digital wallet platform signing the transaction request and forwarding the signed transaction request to a second digital wallet on the second user device.

28. The method of claim 27, wherein the digital wallet platform also transmits a copy of the multi-signed transaction request to the first digital wallet.

29. A method of communicating using a bio-locked token (BLT) in a secure virtualization authentication (SVA) System using enrolled identities, wherein an SVA platform within the SVA System maintains a registry of users, each user in the registry having associated therewith one or more enrolled identities, and each enrolled identity having associated therewith, two public-private key pairs to be used to for bio-locked communications, a first public-private key pair to be used by an SVA client associated with the corresponding enrolled identify and a second public-private key part to be used by the SVA platform, said method comprising:
generating a message from a first enrolled identity to a second enrolled identity;
signing the message with a first key pair associated with the first enrolled identity by an SVA client of the first enrolled identity;
signing the message with a second key pair associated with the first enrolled identity by the SVA platform;
encrypting the signed massage with the public key of the SVA platform and a public key associated with the second enrolled identity; and
transmitting the encrypted message to the second enrolled identity.

30. The method according to claim 29, wherein a user of the first enrolled identity must login to the SVA Platform and be validated prior to the signing steps.

31. The method according to claim 30, wherein said signing and encrypting steps of said SVA Platform are performed by the SVA Platform after the user of the first enrolled identity is validated by the SVA Platform.

32. The method according to claim 31, further comprising steps of:
the second enrolled identity sends the encrypted message to the SVA Platform for decryption using the SVA platform key corresponding to the second enrolled identity maintained at the SVA Platform;
the SVA Platform performs first level decryption of the encrypted message using the second enrolled identity platform key maintained at the SVA Platform.

33. The method according to claim 29, wherein the transmitting step is performed by the user of the first enrolled identity.

34. The method according to claim 29, wherein the transmitting step is performed by the SVA Platform.

35. The method according to claim 32, further comprising steps of:
returning the first level decrypted message to the second enrolled identity only if the user of the second enrolled identity is in a validated state and is the owner of the second enrolled identity.

36. The method according to claim 35, further comprising steps of:
performing second level decryption on the message by the user of the second enrolled identity using the local key of the second enrolled identity; and verification of the decrypted message using the public keys of both the local and the platform keys of the first enrolled identity.
